(19) United States
(12) Patent Application Publication
(10) Pub. No.: US 2020/0195693 A1
(43) Pub. Date: Jun. 18, 2020

(54) Security System Configured to Assign a Group Security Policy to a User Based on Security Risk Posed by the User

(71) Applicant: Forcepoint, LLC, Austin, TX (US)

(72) Inventors: Mark D. Price, Midvale, UT (US); Samuel O. White, Cottonwood Heights, UT (US); Gregory Coleman, Saratoga Springs, UT (US); Delbert B. Brown, American Fork, UT (US); Jeremy L. Fergus, Cottonwood Heights, UT (US)

(21) Appl. No.: 16/220,447

(22) Filed: Dec. 14, 2018

(51) Int. Cl. H04L 29/06; G06F 21/55

(52) U.S. Cl. CPC H04L 63/205; H04L 63/102; H04L 63/1433; G06F 21/552; H04L 63/107

(57) ABSTRACT

A method, system and computer-usable medium are disclosed for assigning a group security policy to a user based on the security risk posed by the user. In certain embodiments, a plurality of group security policies are provided, wherein one or more of the plurality of group security policies have different levels of security enforcement. A security risk assessment for the user is received and a group security policy from the plurality of group security policies is assigned to the user based on the security risk assessment for the user. The assigned group security policy is communicated to a device operated by the user for enforcement of the group security policy at the device.

### BACKGROUND OF THE INVENTION

### Field of the Invention

The present invention relates in general to the field of computers and similar technologies, and in particular to software and hardware utilized in this field. Still more particularly, it relates to a method, system and computer-usable medium configured to assign a group security policy to a user based on the security risk posed by the user.

### Description of the Related Art

Users interact with physical, system, data, and services resources of all kinds, as well as each other, on a daily basis. Each of these interactions, whether accidental or intended, poses some degree of security risk, depending on the behavior of the user. In particular, the actions of a formerly trusted user may become malicious as a result of being subverted, compromised or radicalized due to any number of internal or external factors or stressors. For example, financial pressure, political idealism, irrational thoughts, or other influences may adversely affect a user's intent and/or behavior.

However, not all user behaviors pose the same risk. For example, a user accessing an organization's proprietary resources poses a higher risk than the same user perusing an online website during working hours. Consequently, indiscriminately applying the same policy to all user behavior instead of adjusting security oversight accordingly may result in inefficient utilization of security system resources. However, identifying what may be anomalous, abnormal, unexpected, or malicious user behavior can often prove challenging, as such behavior may not be readily apparent when employing typical security monitoring approaches.

### SUMMARY OF THE INVENTION

A method, system and computer-usable medium are disclosed for assigning a group security policy to a user based on the security risk posed by the user. The system may include one or more computers that can be configured to perform particular operations or actions by virtue of having software, firmware, hardware, or a combination of them installed on the system that in operation causes or cause the system to perform the assignment of the group security policy. One or more computer programs can be configured to perform particular operations or actions by virtue of including instructions that, when executed by data processing apparatus, cause the apparatus to perform the assignment of the group security policy.

Certain embodiments include a computer-implemented method for assigning security policy to a user, including: providing a plurality of group security policies, where one or more of the plurality of group security policies have different levels of security enforcement; receiving a security risk assessment for the user; assigning a group security policy from the plurality of group security policies to the user based on the security risk assessment for the user; and communicating the assigned group security policy to a device operated by the user for enforcement of the group security policy at the device. Other embodiments of this aspect include corresponding computer systems, apparatus, and computer programs recorded on one or more computer storage devices, each configured to perform the actions of the methods. Other embodiments of this aspect of the invention may include corresponding stand-alone and/or network computer systems, apparatus, and computer programs recorded on one or more computer storage devices, each configured to perform one or more of these actions.

Certain embodiments include a system including: a processor; a data bus coupled to the processor; and a non-transitory, computer-readable storage medium embodying computer program code, the non-transitory, computer-readable storage medium being coupled to the data bus, the computer program code interacting with a plurality of computer operations and including instructions executable by the processor and configured for: providing a plurality of group security policies, where one or more of the plurality of group security policies have different levels of security enforcement; receiving a security risk assessment for a user; assigning a group security policy from the plurality of group security policies to the user based on the security risk assessment for the user; and communicating the assigned group security policy to a device operated by the user for enforcement of the group security policy at the device. Other embodiments of this aspect of the invention may include corresponding stand-alone and/or network computer systems, apparatus, and computer programs recorded on one or more computer storage devices, each configured to perform one or more of these actions.

Certain embodiments include a non-transitory, computer-readable storage medium embodying computer program code, the computer program code including computer executable instructions configured for: providing a plurality of group security policies, where one or more of the plurality of group security policies have different levels of security enforcement; receiving a security risk assessment for a user; assigning a group security policy from the plurality of group security policies to the user based on the security risk assessment for the user; and communicating the assigned group security policy to a device operated by the user for enforcement of the group security policy at the device. Other embodiments of this aspect of the invention may include corresponding stand-alone and/or network computer systems, apparatus, and computer programs recorded on one or more computer storage devices, each configured to perform one or more of these actions.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of an edge device;

FIG. 3 is a simplified block diagram of an endpoint agent;

FIG. 4 is a simplified block diagram of a security analytics system;

FIG. 5 is a simplified block diagram of a security analytics system;

FIG. 6 is a generalized process flow diagram of the performance of event queue analytics operations;

FIG. 7 is a generalized process flow diagram of the performance of risk scoring operations;

FIGS. 8a and 8b shows a block diagram of a security analytics system environment;

FIG. 9 is a functional block diagram showing an electronic environment in which certain embodiments of the policy assignment system may operate in accordance with one embodiment of the invention;

FIG. 10 is a flowchart depicting exemplary operations that may be executed by certain embodiments of the policy assignment system;

FIG. 11 includes charts depicting group policy assignments to a plurality of users at different times during operation of the policy assignment system;

FIG. 12 includes another set of charts depicting group policy assignments to a plurality of users at different times during operation of the policy assignment system;

FIG. 13 is a block diagram illustrating one manner in which devices associated with system users may communicate with the security risk and analytics system;

FIG. 14 is a flowchart depicting exemplary operations that may be executed to update a group security policy at an agent; and

FIG. 15 is a block diagram showing one example of an implementation of a unified endpoint system that includes one or more agents that may be used at an endpoint device.

### DETAILED DESCRIPTION

A method, system and computer-usable medium are disclosed for assigning a group security policy to a user based on the security risk posed by the user. Certain aspects of the invention reflect an appreciation that a user's security policy may contain one or more rules preventing the enactment of a particular event.

Certain aspects of the invention reflect an appreciation that a system may have a substantial number of system users and that individual security policies need not necessarily be tailored to specific users on an individual basis. To this end, certain aspects of the invention reflect an appreciation that manual processes related to keeping the rules of a user's associated security policy up to date can be tedious, time consuming, and error-prone. Furthermore, the use of such manual processes may introduce inefficiencies and frustration into day-to-day activities of the user.

Certain aspects of the present invention reflect an appreciation that group security policies may be developed and assigned to respective groups of system users posing similar security risks. As an example, a first group security policy having few security limitations may be assigned to a first group of system users that present a low security risk, while a second group security policy having more substantial security limitations may be assigned to a second group of system users presenting a higher security risk. In this example, endpoint devices operated by the first group of system users will operate in compliance with the first group security policy, while endpoint devices operated by the second group of system users will operate in compliance with the second group security policy.

Certain aspects of the invention reflect an appreciation that group security policies may be dynamically assigned to system users in response to changes in the security risks posed by the users. As an example, a user originally assigned to the first group security policy may be updated to assign the second group security when a security risk assessment for the user indicates that the user poses an increased security risk warranting compliance with the second group security policy at the user's endpoint device.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a mobile device such as a tablet or smartphone, a consumer electronic device, a connected “smart device,” a network appliance, a network storage device, a network gateway device, a server or collection of servers or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more wired or wireless interfaces for communicating with other networked devices, external devices, and various input and output (I/O) devices, such as a keyboard, a mouse, a microphone, speakers, a track pad, a touchscreen and a display device (including a touch sensitive display device). The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or solid state drive), a sequential access storage device (e.g., a tape disk drive), optical storage device, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

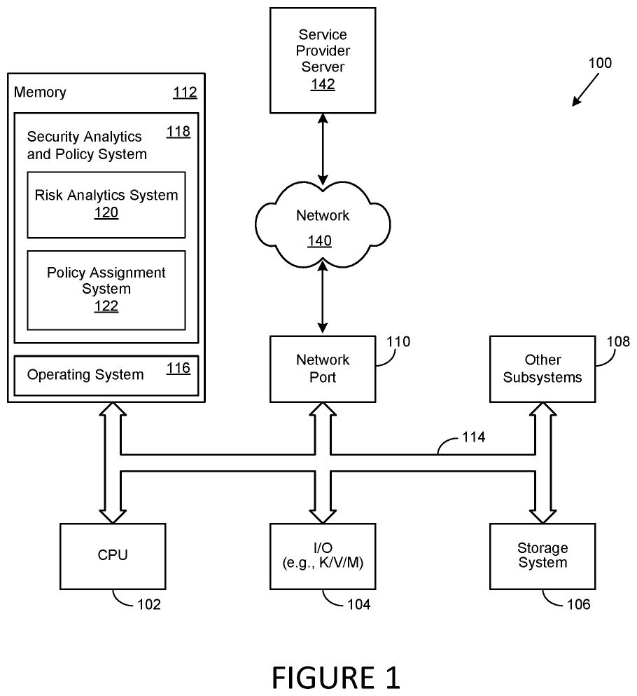

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a storage system 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further includes operating system (OS) 116 and in various embodiments may also include a security analytics and policy system 118. In certain embodiments, the security analytics and policy system 118 includes a risk analytics system 120 and policy assignment system 122. In one embodiment, the information handling system 100 is able to download the security analytics and policy system 118 from the service provider server 142. In another embodiment, the security analytics and policy system 118 is provided as a service from the service provider server 142.

In various embodiments, the security analytics and policy system 118 performs security analytics and security policy assignment operations. In certain embodiments, the security analytics and security policy operations improve processor efficiency, and thus the efficiency of the information handling system 100, by facilitating security analytics and security policy assignment functions. As will be appreciated, once the information handling system 100 is configured to perform the security analytics and security policy assignment operations, the information handling system 100 becomes a specialized computing device specifically configured to perform the security operations that protect the integrity of the information processing system 100 and is not a general purpose computing device. Moreover, the implementation of the security analytics and policy system 118 on the information handling system 100 improves the functionality of the information handling system 100 and provides a useful and concrete result of performing security functions to identify anomalous, abnormal, unexpected, or malicious user behavior and assign corresponding security policies for security risk mitigation. In certain embodiments, the security analytics and policy system 118 may include a risk analytics system 120 and security policy assignment system 122. In certain embodiments, the risk analytics system 120 assesses the security risks associated with system users. In certain embodiments, the policy assignment system 122 uses the security risk assessments provided by the risk analytics system 120 to assign group security policies to groups of system users, where group security policies are assigned to corresponding groups of system users having similar security risk assessments.

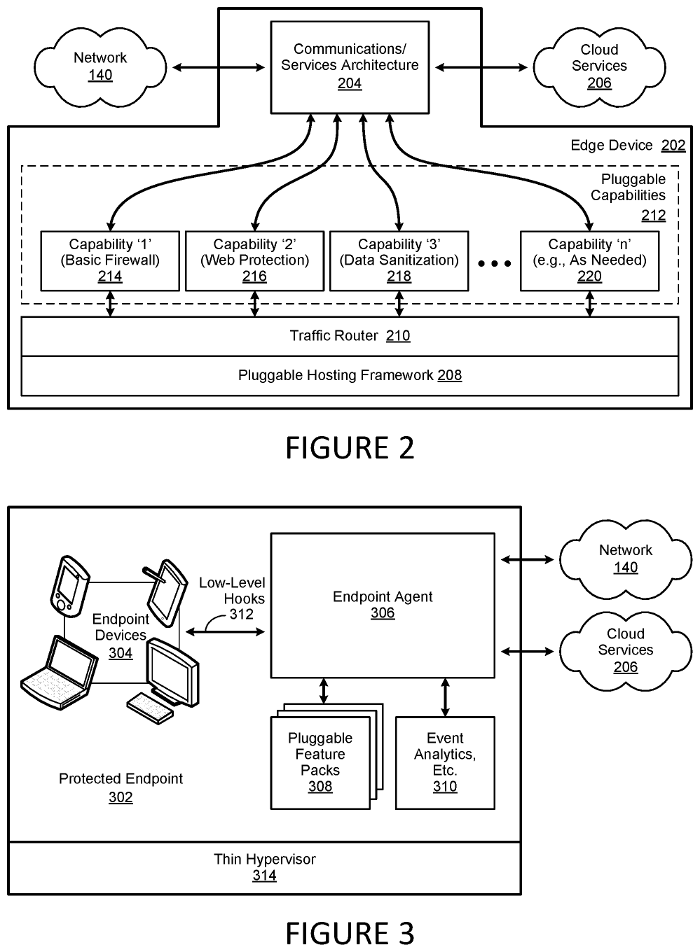

FIG. 2 is a simplified block diagram of an edge device implemented in accordance with an embodiment of the invention. As used herein, an edge device, such as the edge device 202 shown in FIG. 2, broadly refers to a device providing an entry point into a network 140. Examples of such edge devices 202 may include routers, routing switches, integrated access devices (IADs), multiplexers, wide-area network (WAN) access devices, and network security appliances. In certain embodiments, the network 140 may be a private network (e.g., an enterprise network), a semi-public network (e.g., a service provider core network), or a public network (e.g., the Internet).

Skilled practitioners of the art will be aware that edge devices 202 are often implemented as routers that provide authenticated access to faster, more efficient backbone and core networks. Furthermore, current industry trends include making edge devices 202 more intelligent, which allows core devices to operate at higher speed as they are not burdened with additional administrative overhead. Accordingly, such edge devices 202 often include Quality of Service (QoS) and multi-service functions to manage different types of traffic. Consequently, it is common to design core networks with switches that use routing protocols such as Open Shortest Path First (OSPF) or Multiprotocol Label Switching (MPLS) for reliability and scalability. Such approaches allow edge devices 202 to have redundant links to the core network, which not only provides improved reliability, but enables enhanced, flexible, and scalable security capabilities as well.

In certain embodiments, the edge device 202 may be implemented to include a communications/services architecture 204, various pluggable capabilities 212, a traffic router 210, and a pluggable hosting framework 208. In certain embodiments, the communications/services architecture 202 may be implemented to provide access to and from various networks 140, cloud services 206, or a combination thereof. In certain embodiments, the cloud services 206 may be provided by a cloud infrastructure familiar to those of skill in the art. In certain embodiments, the edge device 202 may be implemented to provide support for a variety of generic services, such as directory integration, logging interfaces, update services, and bidirectional risk/context flows associated with various analytics. In certain embodiments, the edge device 202 may be implemented to provide temporal information, described in greater detail herein, associated with the provision of such services.

In certain embodiments, the edge device 202 may be implemented as a generic device configured to host various network communications, data processing, and security management capabilities. In certain embodiments, the pluggable hosting framework 208 may be implemented to host such capabilities in the form of pluggable capabilities 212. In certain embodiments, the pluggable capabilities 212 may include capability ‘1’ 214 (e.g., basic firewall), capability ‘2’ 216 (e.g., general web protection), capability ‘3’ 218 (e.g., data sanitization), and so forth through capability ‘n’ 220, which may include capabilities needed for a particular operation, process, or requirement on an as-needed basis. In certain embodiments, such capabilities may include the performance of operations associated with managing the use of a blockchain to access a cyberprofile, described in greater detail herein, or other sensitive private information (SPI), likewise described in greater detail herein. In certain embodiments, such operations may include the provision of associated temporal information (e.g., time stamps).

In certain embodiments, the pluggable capabilities 212 may be sourced from various cloud services 206. In certain embodiments, the pluggable hosting framework 208 may be implemented to provide certain computing and communication infrastructure components, and foundation capabilities, required by one or more of the pluggable capabilities 212. In certain embodiments, the pluggable hosting framework 208 may be implemented to allow the pluggable capabilities 212 to be dynamically invoked. Skilled practitioners of the art will recognize that many such embodiments are possible. Accordingly, the foregoing is not intended to limit the spirit, scope or intent of the invention.

FIG. 3 is a simplified block diagram of an endpoint agent implemented in accordance with an embodiment of the invention. As used herein, an endpoint agent 306 broadly refers to a software agent used in combination with an endpoint device 304 to establish a protected endpoint 302. Skilled practitioners of the art will be familiar with software agents, which are computer programs that perform actions on behalf of a user or another program. In various approaches, a software agent may be autonomous or work together with another agent or a user. In certain of these approaches the software agent is implemented to autonomously decide if a particular action is appropriate for a given event, such as an observed user behavior.

An endpoint device 304, as likewise used herein, refers to an information processing system such as a personal computer, a laptop computer, a tablet computer, a personal digital assistant (PDA), a smart phone, a mobile telephone, a digital camera, a video camera, or other device that is capable of storing, processing and communicating data. In certain embodiments, the communication of the data may take place in real-time or near-real-time. As used herein, real-time broadly refers to processing and providing information within a time interval brief enough to not be discernable by a user. As an example, a cellular phone conversation may be used to communicate information in real-time, while an instant message (IM) exchange may be used to communicate information in near real-time. In certain embodiments, the communication of the information may take place asynchronously. For example, an email message may be stored on an endpoint device 304 when it is offline. In this example, the information may be communicated to its intended recipient once the endpoint device 304 gains access to a network 140.

A protected endpoint 302, as likewise used herein, broadly refers to a policy-based approach to network security that typically requires endpoint devices 304 to comply with particular criteria before they are granted access to network resources. As an example, a given endpoint device 304 may be required to have a particular operating system (OS), or version thereof, a Virtual Private Network (VPN) client, anti-virus software with current updates, and so forth. In certain embodiments, the protected endpoint 302 may be implemented to perform operations associated with providing real-time resolution of the identity of an entity at a particular point in time, as described in greater detail herein. In certain embodiments, the protected endpoint 302 may be implemented to provide temporal information, such as timestamp information, associated with such operations.

In certain embodiments, the real-time resolution of the identity of an entity at a particular point in time may be based upon contextual information associated with a given user behavior. As used herein, contextual information broadly refers to any information, directly or indirectly, individually or in combination, related to a particular user behavior. In certain embodiments, user behavior may include a user's physical behavior, cyber behavior, or a combination thereof. As likewise used herein, physical behavior broadly refers to any user behavior occurring within a physical realm. More particularly, physical behavior may include any action enacted by a user that can be objectively observed, or indirectly inferred, within a physical realm.

As an example, a user may attempt to use an electronic access card to enter a secured building at a certain time. In this example, the use of the access card to enter the building is the action and the reading of the access card makes the user's physical behavior electronically-observable. As another example, a first user may physically transfer a document to a second user, which is captured by a video surveillance system. In this example, the physical transferal of the document from the first user to the second user is the action. Likewise, the video record of the transferal makes the first and second user's physical behavior electronically-observable. As used herein, electronically-observable user behavior broadly refers to any behavior exhibited or enacted by an entity that can be electronically observed.

Cyber behavior, as used herein, broadly refers to any behavior occurring in cyberspace, whether enacted by an individual user, a group of users, or a system acting at the behest of an individual user, a group of users, or an entity. More particularly, cyber behavior may include physical, social, or mental actions that can be objectively observed, or indirectly inferred, within cyberspace. As an example, a user may use an endpoint device 304 to access and browse a particular website on the Internet. In this example, the individual actions performed by the user to access and browse the website constitute a cyber behavior. As another example, a user may use an endpoint device 304 to download a data file from a particular system at a particular point in time. In this example, the individual actions performed by the user to download the data file, and associated temporal information, such as a time-stamp associated with the download, constitute a cyber behavior. In these examples, the actions are enacted within cyberspace, in combination with associated temporal information, makes them electronically-observable.

As likewise used herein, cyberspace broadly refers to a network 140 environment capable of supporting communication between two or more entities. In certain embodiments, the entity may be a user, an endpoint device 304, or various resources, described in greater detail herein. In certain embodiments, the entities may include various endpoint devices 304 or resources operating at the behest of an entity, such as a user. In certain embodiments, the communication between the entities may include audio, image, video, text, or binary data.

As described in greater detail herein, the contextual information may include a user's authentication factors 604. Contextual information may likewise include various temporal identity resolution factors, such as identification factors associated with the user, the date/time/frequency of various user behaviors, the user's location, the user's role or position in an organization, their associated access rights, and certain user gestures employed by the user in the enactment of a user behavior. Other contextual information may likewise include various user interactions, whether the interactions are with an endpoint device 304, a network 140, a resource, or another user. In certain embodiments, user behaviors, and their related contextual information, may be collected at particular points of observation, and at particular points in time, described in greater detail herein.

In certain embodiments, the endpoint agent 306 may be implemented to universally support a variety of operating systems, such as Apple Macintosh®, Microsoft Windows®, Linux®, Android® and so forth. In certain embodiments, the endpoint agent 306 may be implemented to interact with the endpoint device 304 through the use of low-level hooks 312 at the OS level. It will be appreciated that the use of low-level hooks 312 allows the endpoint agent 306 to subscribe to multiple events through a single hook. Consequently, multiple functionalities provided by the endpoint agent 306 can share a single data stream, using only those portions of the data stream they may individually need. Accordingly, system efficiency can be improved and operational overhead reduced.

In certain embodiments, the endpoint agent 306 may be implemented to provide a common infrastructure for pluggable feature packs 308. In various embodiments, the pluggable feature packs 308 may provide certain security management functionalities. Examples of such functionalities may include various anti-virus and malware detection, data loss protection (DLP), insider threat detection, and so forth. In certain embodiments, the security management functionalities may include one or more functionalities associated with providing real-time resolution of the identity of an entity at a particular point in time, as described in greater detail herein.

In certain embodiments, a particular pluggable feature pack 308 is invoked as needed by the endpoint agent 306 to provide a given functionality. In certain embodiments, individual features of a particular pluggable feature pack 308 are invoked as needed. It will be appreciated that the ability to invoke individual features of a pluggable feature pack 308, without necessarily invoking all such features, will likely improve the operational efficiency of the endpoint agent 306 while simultaneously reducing operational overhead. Accordingly, the endpoint agent 306 can self-optimize in certain embodiments by using the common infrastructure and invoking only those pluggable components that are applicable or needed for a given user behavior.

In certain embodiments, the individual features of a pluggable feature pack 308 are invoked by the endpoint agent 306 according to the occurrence of a particular user behavior. In certain embodiments, the individual features of a pluggable feature pack 308 are invoked by the endpoint agent 306 according to the occurrence of a particular temporal event, described in greater detail herein. In certain embodiments, the individual features of a pluggable feature pack 308 are invoked by the endpoint agent 306 at a particular point in time. In these embodiments, the method by which a given user behavior, temporal event, or point in time is selected is a matter of design choice.

In certain embodiments, the individual features of a pluggable feature pack 308 may be invoked by the endpoint agent 306 according to the context of a particular user behavior. As an example, the context may be the user enacting the user behavior, their associated risk classification, which resource they may be requesting, the point in time the user behavior is enacted, and so forth. In certain embodiments, the pluggable feature packs 308 may be sourced from various cloud services 206. In certain embodiments, the pluggable feature packs 308 may be dynamically sourced from various cloud services 206 by the endpoint agent 306 on an as-need basis.

In certain embodiments, the endpoint agent 306 may be implemented with additional functionalities, such as event analytics 310. In certain embodiments, the event analytics 310 functionality may include analysis of various user behaviors, described in greater detail herein. In certain embodiments, the endpoint agent 306 may be implemented with a thin hypervisor 314, which can be run at Ring −1, thereby providing protection for the endpoint agent 306 in the event of a breach. As used herein, a thin hypervisor broadly refers to a simplified, OS-dependent hypervisor implemented to increase security. As likewise used herein, Ring −1 broadly refers to approaches allowing guest operating systems to run Ring 0 (i.e., kernel) operations without affecting other guests or the host OS. Those of skill in the art will recognize that many such embodiments and examples are possible. Accordingly, the foregoing is not intended to limit the spirit, scope or intent of the invention.

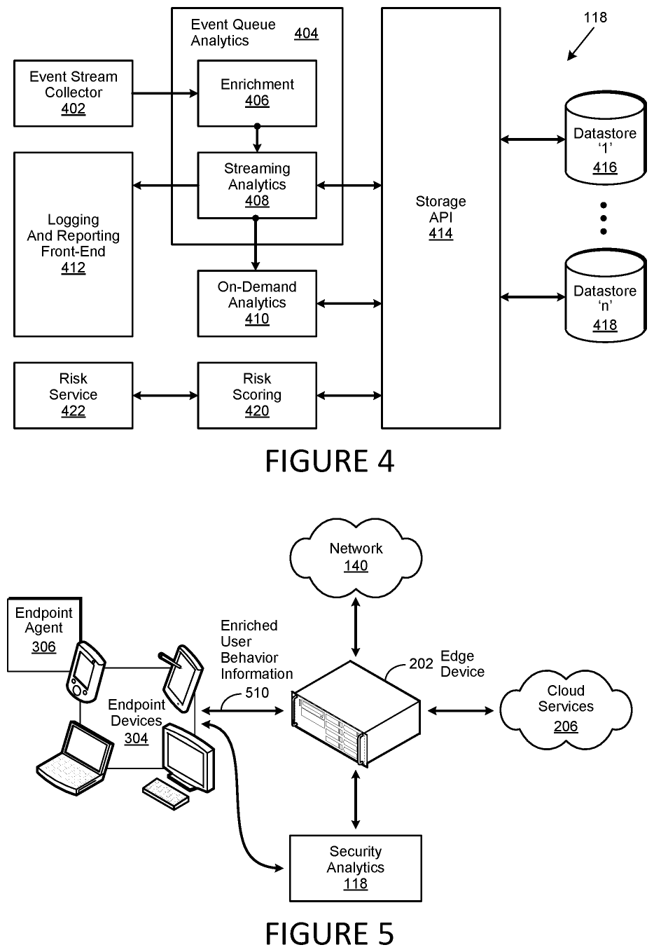

FIG. 4 is a simplified block diagram of a security analytics system implemented in accordance with an embodiment of the invention. In certain embodiments, the security analytics and policy system 118 shown in FIG. 4 may include an event queue analytics 404 module, described in greater detail herein. In certain embodiments, the event queue analytics 404 sub-system may be implemented to include an enrichment 406 module and a streaming analytics 408 module. In certain embodiments, the security analytics and policy system 118 may be implemented to provide log storage, reporting, and analytics capable of performing streaming 408 and on-demand 410 analytics operations. In certain embodiments, such operations may be associated with defining and managing a user profile, detecting anomalous, abnormal, unexpected or malicious user behavior, adaptively responding to mitigate risk, or a combination thereof, as described in greater detail herein.

In certain embodiments, the security analytics and policy system 118 may be implemented to provide a uniform platform for storing events and contextual information associated with various user behaviors and performing longitudinal analytics. As used herein, longitudinal analytics broadly refers to performing analytics of user behaviors occurring over a particular period of time. As an example, a user may iteratively attempt to access certain proprietary information stored in various locations. In addition, the attempts may occur over a brief period of time. To continue the example, the fact that the information the user is attempting to access is proprietary, that it is stored in various locations, and the attempts are occurring in a brief period of time, in combination, may indicate the user behavior enacted by the user is suspicious. As another example, certain entity identifier information (e.g., a user name) associated with a user may change over time. In this example, the change in user name, during a particular period of time or at a particular point in time, may represent suspicious user behavior.

In certain embodiments, the security analytics and policy system 118 may be implemented to be scalable. In certain embodiments, the security analytics and policy system 118 may be implemented in a centralized location, such as a corporate data center. In these embodiments, additional resources may be added to the security analytics and policy system 118 as needs grow. In certain embodiments, the security analytics and policy system 118 may be implemented as a distributed system. In these embodiments, the security analytics and policy system 118 may span multiple information handling systems. In certain embodiments, the security analytics and policy system 118 may be implemented in a cloud environment. In certain embodiments, the security analytics and policy system 118 may be implemented in a virtual machine (VM) environment. In such embodiments, the VM environment may be configured to dynamically and seamlessly scale the security analytics and policy system 118 as needed. Skilled practitioners of the art will recognize that many such embodiments are possible. Accordingly, the foregoing is not intended to limit the spirit, scope or intent of the invention.

In certain embodiments, an event stream collector 402 may be implemented to collect event and related contextual information, described in greater detail herein, associated with various user behaviors. In these embodiments, the method by which the event and contextual information is selected to be collected by the event stream collector 402 is a matter of design choice. In certain embodiments, the event and contextual information collected by the event stream collector 402 may be processed by an enrichment module 406 to generate enriched user behavior information. In certain embodiments, the enrichment may include certain contextual information related to a particular user behavior or event. In certain embodiments, the enrichment may include certain temporal information, such as timestamp information, related to a particular user behavior or event.

In certain embodiments, enriched user behavior information may be provided by the enrichment module 406 to a streaming 408 analytics module. In turn, the streaming 408 analytics module may provide some or all of the enriched user behavior information to an on-demand 410 analytics module. As used herein, streaming 408 analytics broadly refers to analytics performed in near real-time on enriched user behavior information as it is received. Likewise, on-demand 410 analytics broadly refers herein to analytics performed, as they are requested, on enriched user behavior information after it has been received. In certain embodiments, the enriched user behavior information may be associated with a particular event. In certain embodiments, the enrichment 406 and streaming analytics 408 modules may be implemented to perform event queue analytics 404 operations, as described in greater detail herein.

In certain embodiments, the on-demand 410 analytics may be performed on enriched user behavior associated with a particular interval of, or point in, time. In certain embodiments, the streaming 408 or on-demand 410 analytics may be performed on enriched user behavior associated with a particular user, group of users, one or more entities, or a combination thereof. In certain embodiments, the streaming 408 or on-demand 410 analytics may be performed on enriched user behavior associated with a particular resource, such as a facility, system, datastore, or service. Those of skill in the art will recognize that many such embodiments are possible. Accordingly, the foregoing is not intended to limit the spirit, scope or intent of the invention.

In certain embodiments, the results of various analytics operations performed by the streaming 408 or on-demand 410 analytics modules may be provided to a storage Application Program Interface (API) 414. In turn, the storage API 412 may be implemented to provide access to various datastores ‘1’ 416 through ‘n’ 418, which in turn are used to store the results of the analytics operations. In certain embodiments, the security analytics and policy system 118 may be implemented with a logging and reporting front-end 412, which is used to receive the results of analytics operations performed by the streaming 408 analytics module. In certain embodiments, the datastores ‘1’ 416 through ‘n’ 418 may variously include a datastore of entity identifiers, temporal events, or a combination thereof.

In certain embodiments, the security analytics and policy system 118 may include a risk scoring 420 module implemented to perform risk scoring operations, described in greater detail herein. In certain embodiments, functionalities of the risk scoring 420 module may be provided in the form of a risk management service 422. In certain embodiments, the risk management service 422 may be implemented to perform operations associated with defining and managing a user profile, as described in greater detail herein. In certain embodiments, the risk management service 422 may be implemented to perform operations associated with detecting anomalous, abnormal, unexpected or malicious user behavior and adaptively responding to mitigate risk, as described in greater detail herein. In certain embodiments, the risk management service 422 may be implemented to provide the results of various analytics operations performed by the streaming 406 or on-demand 408 analytics modules. In certain embodiments, the risk management service 422 may be implemented to use the storage API 412 to access various enhanced cyber behavior and analytics information stored on the datastores ‘1’ 414 through ‘n’ 416. Skilled practitioners of the art will recognize that many such embodiments are possible. Accordingly, the foregoing is not intended to limit the spirit, scope or intent of the invention.

FIG. 5 is a simplified block diagram of the operation of a security analytics system implemented in accordance with an embodiment of the invention. In certain embodiments, the security analytics and policy system 118 may be implemented to perform operations associated with detecting anomalous, abnormal, unexpected or malicious user behavior, as described in greater detail herein. In certain embodiments, the security analytics and policy system 118 may be implemented in combination with one or more endpoint agents 306, one or more edge devices 202, various cloud services 206, and a network 140 to perform such operations.

In certain embodiments, the network edge device 202 may be implemented in a bridge, a firewall, or a passive monitoring configuration. In certain embodiments, the edge device 202 may be implemented as software running on an information handling system. In certain embodiments, the network edge device 202 may be implemented to provide integrated logging, updating and control. In certain embodiments, the edge device 202 may be implemented to receive network requests and context-sensitive user behavior information in the form of enriched user behavior information 510, described in greater detail herein, from an endpoint agent 306, likewise described in greater detail herein.

In certain embodiments, the security analytics and policy system 118 may be implemented as both a source and a sink of user behavior information. In certain embodiments, the security analytics and policy system 118 may be implemented to serve requests for user/resource risk data. In certain embodiments, the edge device 202 and the endpoint agent 306, individually or in combination, may provide certain user behavior information to the security analytics and policy system 118 using either push or pull approaches familiar to skilled practitioners of the art.

As described in greater detail herein, the edge device 202 may be implemented in certain embodiments to receive enriched user behavior information 510 from the endpoint agent 306. It will be appreciated that such enriched user behavior information 510 will likely not be available for provision to the edge device 202 when an endpoint agent 306 is not implemented for a corresponding endpoint device 304. However, the lack of such enriched user behavior information 510 may be accommodated in various embodiments, albeit with reduced functionality related to operations associated with defining and managing a user profile, detecting anomalous, abnormal, unexpected or malicious user behavior, mitigating associated risk, or a combination thereof.

In certain embodiments, a given user behavior may be enriched by an associated endpoint agent 306 attaching contextual information to a request. In certain embodiments, the context is embedded within a network request, which is then provided as enriched user behavior information 510. In certain embodiments, the contextual information may be concatenated, or appended, to a request, which in turn may be provided as enriched user behavior information 510. In these embodiments, the enriched user behavior information 510 may be unpacked upon receipt and parsed to separate the request and its associated contextual information. Certain embodiments of the invention reflect an appreciation that one possible disadvantage of such an approach is that it may perturb certain Intrusion Detection System and/or Intrusion Detection Prevention (IDS/IDP) systems implemented on a network 140.

In certain embodiments, new flow requests may be accompanied by a contextual information packet sent to the edge device 202. In these embodiments, the new flow requests may be provided as enriched user behavior information 510. In certain embodiments, the endpoint agent 306 may also send updated contextual information to the edge device 202 once it becomes available. As an example, an endpoint agent 306 may share a list of files that have been read by a current process at any point in time once the information has been collected. To continue the example, such a list of files may be used to determine which data the endpoint agent 306 may be attempting to exfiltrate.

In certain embodiments, point analytics processes executing on the edge device 202 may request a particular service. As an example, risk scores associated with a particular event on a per-user basis may be requested. In certain embodiments, the service may be requested from the security analytics and policy system 118. In certain embodiments, the service may be requested from various cloud services 206.

In certain embodiments, contextual information associated with a particular user behavior may be attached to various network service requests. In certain embodiments, the request may be wrapped and then handled by proxy. In certain embodiments, a small packet of contextual information associated with a user behavior may be sent with a service request. In certain embodiments, service requests may be related to Domain Name Service (DNS), web browsing activity, email, and so forth, all of which are essentially requests for service by an endpoint device 304. In certain embodiments, such service requests may be associated with temporal event information, described in greater detail herein. Consequently, such requests can be enriched by the addition of user behavior contextual information (e.g., UserAccount, interactive/automated, data-touched, temporal event information, etc.). Accordingly, the edge device 202 can then use this information to manage the appropriate response to submitted requests.

In certain embodiments, the security analytics and policy system 118 may be implemented in different operational configurations. In certain embodiments, the security analytics and policy system 118 may be implemented by using the endpoint agent 306. In certain embodiments, the security analytics and policy system 118 may be implemented by using endpoint agent 306 in combination with the edge device 202. In certain embodiments, the cloud services 206 may likewise be implemented for use by the endpoint agent 306, the edge device 202, and the security analytics system 118, individually or in combination. In these embodiments, the security analytics system 118 may be primarily oriented to performing risk assessment operations related to user actions, program actions, data accesses, or a combination thereof. In certain embodiments, program actions may be treated as a proxy for the user.

In certain embodiments, the endpoint agent 306 may be implemented to update the security analytics and policy system 118 with user behavior and associated contextual information, thereby allowing an offload of certain analytics processing overhead. In certain embodiments, this approach allows for longitudinal risk scoring, which assesses risk associated with certain user behavior during a particular interval of time. In certain embodiments, the security analytics and policy system 118 may be implemented to access risk scores associated with the same user account, but accrued on different endpoint devices 304. It will be appreciated that such an approach may prove advantageous when an adversary is “moving sideways” through a network environment, using different endpoint devices 304 to collect information.

In certain embodiments, the security analytics and policy system 118 may be primarily oriented to applying risk mitigations in a way that maximizes security effort return-on-investment (ROI). In certain embodiments, this approach may be accomplished by providing additional contextual and user behavior information associated with user requests. As an example, a web gateway may not concern itself with why a particular file is being requested by a certain entity at a particular point in time. Accordingly, if the file cannot be identified as malicious or harmless, there is no context available to determine how, or if, to proceed. To extend the example, the edge device 202 and security analytics and policy system 118 may be coupled such that requests can be contextualized and fitted into a framework that evaluates their associated risk. Certain embodiments of the invention reflect an appreciation that such an approach works well with web-based data loss protection (DLP) approaches, as each transfer is no longer examined in isolation, but in the broader context of an identified user's actions, at a particular time, on the network 140.

As another example, the security analytics and policy system 118 may be implemented to perform risk scoring processes to decide whether to block or allow unusual flows. Certain embodiments of the invention reflect an appreciation that such an approach is highly applicable to defending against point-of-sale (POS) malware, a breach technique that has become increasingly more common in recent years. Certain embodiments of the invention likewise reflect an appreciation that while various edge device 202 implementations may not stop all such exfiltrations, they may be able to complicate the task for the attacker.

In certain embodiments, the security analytics and policy system 118 may be primarily oriented to maximally leverage contextual information associated with various user behaviors within the system. In certain embodiments, data flow tracking is performed by one or more endpoint agents 306, which allows the quantity and type of information associated with particular hosts to be measured. In turn, this information may be used to determine how the edge device 202 handles requests. By contextualizing such user behavior on the network 140, the security analytics and policy system 118 can provide intelligent protection, making decisions that make sense in the broader context of an organization's activities. Certain embodiments of the invention reflect an appreciation that one advantage to such an approach is that information flowing through an organization, and the networks they employ, should be trackable, and substantial data breaches preventable. Skilled practitioners of the art will recognize that many such embodiments and examples are possible. Accordingly, the foregoing is not intended to limit the spirit, scope or intent of the invention.

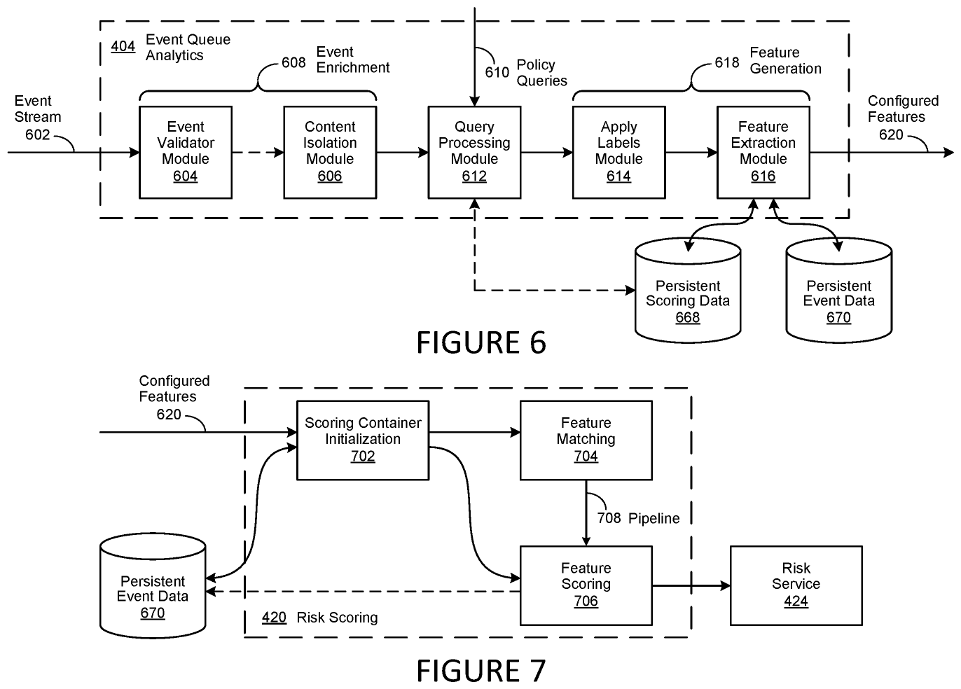

FIG. 6 is a generalized process flow diagram of the performance of event queue analytics operations implemented in accordance with an embodiment of the invention. As used herein, an event broadly refers to the occurrence of an action performed by an entity. In certain embodiments, the action may be directly associated with a user behavior, described in greater detail herein. As an example, a first user may attach a binary file infected with a virus to an email that is subsequently sent to a second user. In this example, the act of attaching the binary file to the email is directly associated with a user behavior enacted by the first user. In certain embodiments, the action may be indirectly associated with a user behavior. To continue the example, the recipient of the email may open the infected binary file, and as a result, infect their computer with malware. To further continue the example, the act of opening the infected binary file is directly associated with a user behavior enacted by the second user. However, the infection of the email recipient's computer by the infected binary file is indirectly associated with the described user behavior enacted by the second user.

As likewise used herein, an entity broadly refers to something that exists as itself, whether physically or abstractly. In certain embodiments, an entity may be an individual user, a group, an organization, or a government. In certain embodiments, an entity may likewise be an item, a device, such as endpoint 304 and edge 202 devices, a network, such as an internal or external network, a domain, an operation, or a process. In certain embodiments, an entity may be a resource, such as a geographical location or formation, a physical facility, such as a venue, various physical security devices, a system, shared devices, such as printer, scanner, or copier, a data store, or a service, such as a service operating in a cloud environment.

In various embodiments, a security analytics system, described in greater detail herein, may be implemented to process certain entity information associated with an event. As used herein, entity information broadly refers to information associated with a particular entity. In various embodiments, the entity information may include certain types of content. In certain embodiments, such content may include text, unstructured data, structured data, graphical images, photographs, audio recordings, video recordings, biometric information, and so forth. In certain embodiments, the entity information may include metadata. In certain embodiments, the metadata may include entity attributes, which in turn may include certain entity identifier types or classifications.

As likewise used herein, a security policy broadly refers to a combination of a rule and an associated action, where the rule defines an event, an allowable behavior, or a combination thereof, and the action describes a corresponding response should the bounds of the rule be met or exceeded. In certain embodiments, the behavior may include a user behavior, described in greater detail herein. In certain embodiments, the rule may include one or more parameters, factors, limits, restrictions, constraints, numeric values, numeric operators, Boolean operators, or a combination thereof. In certain embodiments, the action may include a response, a function, an operation, a procedure, a process, a method, or a combination thereof. In certain embodiments, the action may be performed automatically, semi-automatically, or manually.

As an example, a security policy may include a rule that an email, or a corresponding attachment, contain no more than two Social Security Numbers. In this example, the associated action may be not allowing the email to be sent to its intended recipient, quarantining the email for investigation, and notifying a security administrator to perform the investigation. To continue the example, a user may attempt to illicitly send an email with an attached spreadsheet containing Social Security Numbers, and other sensitive personal information (SPI), associated with a large group of employees to a rival organization. As a result of the security policy being enforced, the rival organization would be prevented from receiving the email, which would also be quarantined for investigation by a security administrator.

In various embodiments, the security analytics system may be implemented to use certain entity identifier information to ascertain the identity of an associated entity at a particular point in time. As used herein, entity identifier information broadly refers to an information element of an entity that can be used to ascertain or corroborate the identity of an associated entity at a particular point in time. In certain embodiments, the entity identifier information may include user authentication factors, user profile attributes, location data, information associated with various endpoint and edge devices, internal and external networks, resource entities, or a combination thereof.

In various embodiments, the entity identifier information may include certain temporal information. As used herein, temporal information broadly refers to a measure of time (e.g., a date, timestamp, etc.), a measure of an interval of time (e.g., a minute, hour, day, between Jun. 3, 2017 and Mar. 4, 2018, etc.). In certain embodiments, the temporal information may be associated with an event associated with a particular point in time. As used herein, such a temporal event broadly refers to an occurrence, action or activity enacted by, or associated with, an entity at a particular point in time.

Examples of such temporal events include making a phone call, sending a text or an email, using a device, such as an endpoint device, accessing a system, interacting with a physical security device or shared devices, and entering a physical facility. Other examples of temporal events include uploading, transferring, downloading, modifying, or deleting data, such as data stored in a datastore, or accessing a service. Yet other examples of temporal events include user/user interactions between two or more users, user/device interactions between a user and a device, user/network interactions between a user and a network, and user/resource interactions between a user and a resource, whether physical or otherwise. Yet still other examples of temporal events include a change in name, address, physical location, occupation, position, role, marital status, gender, association, affiliation, or assignment.

As likewise used herein, temporal event information broadly refers to temporal information associated with a particular event. In various embodiments, the temporal event information may include certain types of content. In certain embodiments, such types of content may include text, unstructured data, structured data, graphical images, photographs, audio recordings, video recordings, and so forth. In certain embodiments, the entity information may include metadata. In various embodiments, the metadata may include temporal event attributes, which in turn may include certain entity identifier types or classifications, described in greater detail herein.

In certain embodiments, the security analytics system may be implemented to use information associated with such temporal resolution of an entity's identity to assess the risk associated with a particular entity, at a particular point in time, and adaptively respond with an associated response. In certain embodiments, the security analytics system may be implemented to respond to such assessments in order to reduce operational overhead and improve system efficiency while maintaining security integrity. In certain embodiments, the response to such assessments may be performed by a security administrator. Accordingly, certain embodiments of the invention may be directed towards assessing the risk associated with the affirmative resolution of the identity of an entity at a particular point in time in combination with its associated contextual information. Consequently, the security analytics system may be more oriented in various embodiments to risk adaptation than to security administration.

In certain embodiments, the security analytics system may be implemented to detect anomalous, abnormal, unexpected or malicious user behavior by determining the probabilities of various possible outcomes occurring within a particular sample space. A sample space, as likewise used herein, broadly refers to the set of all possible outcomes of a particular phenomenon being observed. In certain embodiments, the phenomenon being observed may be an event, described in greater detail herein. In various embodiments, the phenomenon being observed is a matter of design choice.

In certain embodiments, the sample may be the occurrence of a feature associated with a corresponding event. In certain embodiments, such a feature may be associated with anomalous, abnormal, unexpected or malicious user behavior, as described in greater detail herein. In certain embodiments, the occurrence of an unlikely feature associated with a particular entity may result in the generation of a corresponding risk score. In certain embodiments, the generation of a corresponding risk score may include computing the aggregation of occurrences of certain unlikely features with which an entity may be associated.

In certain embodiments, the resulting risk score may be assigned, or otherwise associated, with the entity associated with the occurrence of an unlikely feature. In certain embodiments, the assigned risk score may be implemented to reflect a security risk corresponding to the entity associated with the occurrence of the unlikely feature. In certain embodiments, multiple occurrences of an unlikely feature within a particular period of time may increase an assigned risk score.

In certain embodiments, the event queue analytics 404 operations may be implemented to determine whether or not a feature associated with a particular document matches one or more policy queries 610. In certain embodiments, the document may be associated with a particular event. As used herein, a document broadly refers to a body of content. In certain embodiments, such content may include text, unstructured data, structured data, graphical images, photographs, audio recordings, video recordings, biometric information, metadata, and so forth. In certain embodiments, the policy query 610 may include data, metadata, or a combination thereof, related to an event.

In certain embodiments the policy queries 610 may be defined in a Domain Specific Language. As likewise used herein, a Domain Specific Language (DSL) broadly refers to a computer language specialized to a particular application domain. Examples of DSLs include Hypertext Mark-up Language (HTML) for web pages, Mathematica® for symbolic mathematics, Structured Query Language (SQL) for relational database queries, and Query DSL (QDSL) for Elasticsearch queries.

Referring now to FIG. 6, event queue analytics 404 operations may be initiated in certain embodiments by individual events in an event stream 602 being received and enriched by various event enrichment 608 modules. As used herein, event enrichment broadly refers to performing certain data enrichment operations and processes associated with enriching data associated with a particular event in the event stream 602. As likewise used herein, data enrichment broadly refers to various operations and processes typically used to enhance, refine or otherwise improve raw data.

Examples of geographic data enrichment may include the use of postal code, county name, longitude and latitude, and political district data, while examples of behavioral data enrichment may include purchase, credit risk, and preferred communication channel data. Likewise, examples of demographic data enrichment may include the use of income, marital status, and education data, while examples of psychographic data enrichment may include interests and political affiliation data.

In certain embodiments, event enrichment 608 may include matching certain incoming events in the event stream 602 with existing event data. In certain embodiments, event enrichment 608 may include deleting certain data associated with certain incoming events in the event stream 602. For example, certain data associated with various incoming events may be determined to be irrelevant to the detection of anomalous, abnormal, unexpected or malicious user behavior. In certain embodiments, the method by which data associated with various incoming events is determined to be irrelevant is a matter of design choice.

In certain embodiments, event enrichment 608 may include correcting invalid data associated with certain incoming events in the event stream 602. In certain embodiments, event enrichment 608 may include interpolating data associated with certain incoming events in the event stream 602 with other event data. In certain embodiments, the existing event data may be stored in a repository of persistent event data 670.

For example, an event in the event stream 602 may be associated with a first user attaching a binary file to an email addressed to a second user. In this example, the event enrichment 608 process may include determining the file type of the attachment. Likewise, the event enrichment 608 process may include determining the size of the attachment, the date and time of the email, the address of the originating email server, the email addresses of the first and second user, and so forth. In certain embodiments, the event enrichment 608 process may include associating annotations or other metadata corresponding to such determinations with the event.

In certain embodiments, the event enrichment 608 modules may include an event validator module 604. In certain embodiments, the event validator 604 module may be implemented to perform data validation operations on data associated with a particular event. As used herein, data validation broadly refers to various operations and processes associated with data cleansing to ensure data quality. As likewise used herein, data cleansing broadly refers to the process of detecting, correcting, and possibly removing, corrupted or inaccurate elements from a data set. In various embodiments, data cleansing operations may include identifying incomplete, incorrect, inaccurate, or irrelevant data elements and then replacing, modifying or deleting certain data elements that fail to meet certain data use parameters.

In certain embodiments, the event validator 604 module may be implemented to perform data validation operations without the use of statistical data. In certain embodiments, the event validator 604 module may be implemented to validate that event timestamps fall within a particular interval of time. In certain embodiments, the interval of time may be user-defined or otherwise configurable. In these embodiments, the definition of the interval of time is a matter of design choice. In certain embodiments, the event validator 604 module may be implemented such that an alias for an entity does not exceed a certain number of characters. In these embodiments, the number of characters is a matter of design choice. In certain embodiments, the event validator 604 module may be implemented such that any attested metadata has an expected, corresponding type. In these embodiments, the expected type of metadata is a matter of design choice.

In certain embodiments, the resulting validated event data may be consistent with substantively similar data sets used by the security analytics system to detect anomalous, abnormal, unexpected or malicious user behavior. Certain embodiments of the invention reflect an appreciation that the intent of such data validation is to ensure fitness, accuracy and consistency of data associated with a particular event. Certain embodiments of the invention likewise reflect an appreciation that such fitness, accuracy and consistency is advantageous when performing operations associated with detecting anomalous, abnormal, unexpected or malicious user behavior.

In certain embodiments, the event enrichment 608 modules may include modules (not shown) implemented to perform operations associated with de-duplication, entity resolution, attachment enrichment, domain enrichment, or some combination thereof. As used herein, de-duplication operations broadly refer to operations for determining a unique identity for an event based upon certain identifying fields. In certain embodiments, the identifying fields may include an externally-generated concept, idea or notion provided by the data source from which the event originated. In various embodiments, the identifying fields may include certain fields deemed to be fundamental to the identity of an event, or identification thereof. In certain embodiments, the value of an identifying field may be taken as imprecise with configurable granularity. For example, events that appear to be similar, and have timestamps within one minute of one another, may be considered duplicates.

As likewise used herein, entity resolution operations broadly refer to operations for resolving certain raw identifiers in input data to known entities. In certain embodiments, the resulting known entities may be used by a risk-adaptive protection system to detect anomalous, abnormal, unexpected or malicious user behavior. Likewise, as used herein, attachment enrichment operations broadly refer to operations for adding metadata based upon the quantity or type of data associated with an event. In certain embodiments, the metadata may be determined by extension, mime type headers, or mime type, as inferred from content associated with an event. As used herein, de-duplication operations broadly refer to operations for adding metadata based upon configurable categorizations of domains of entity identifiers associated with the event. In certain embodiments, the metadata may be internal or external to an organization, a particular business unit, government agency, and so forth.

In certain embodiments, the event enrichment 608 modules may likewise include a content isolation 606 module. In certain embodiments, the content isolation 606 module may be implemented to recognize and isolate certain types of recurring content. Examples of such recurring content may include standardized text, such as disclaimers or various types of boilerplate. Other examples of recurring content may include graphical images such as logos, icons, user avatars, and so forth. Certain embodiments of the invention reflect an appreciation that the inclusion of such recurring content in certain risk-adaptive protection operations may result in less effective detection of anomalous, abnormal, unexpected or malicious user behavior. Accordingly, certain embodiments of the invention may not include content that has been isolated by the content isolation 606 module when detecting anomalous, abnormal, unexpected or malicious user behavior, as described in greater detail herein.

In certain embodiments, the resulting, enriched events are then provided to a query processing 612 module. In certain embodiments, the query processing 612 module may be implemented to provide a streaming query framework. In certain embodiments, the streaming query framework may be implemented to process policy queries 610 in the performance of operations associated with detecting anomalous, abnormal, unexpected or malicious user behavior. In certain embodiments, such operations may be performed automatically, semi-manually, or manually in real-time, in batch mode, or on-demand.

In certain embodiments, the query processing 612 module may be implemented to receive certain policy queries 610 that include terms, features, tags, or other items of interest that may be associated with certain interrelated events. As used herein, a term broadly refers to a word, compound word, multi-word expression, numeric value, or alphanumeric string, which in certain contexts is associated with a particular meaning. In certain embodiments, a term may be associated with an event, a feature of an event, a classification label, a metadata tag label, or a combination thereof. In certain embodiments, the event, the feature of an event, the classification label, the metadata tag label, or a combination thereof, may in turn be associated with a particular security policy.

In certain embodiments, the query processing 612 module may be implemented to determine the commonalities between such policy queries 610. In certain embodiments, the query processing 612 module may be implemented to lazily evaluate such features or other terms of interest, as described in greater detail herein. In certain embodiments, the query processing 612 module may be implemented to only evaluate features or other terms of interest needed for the evaluation of a particular event. In certain embodiments, the query processing 612 module may be implemented to only evaluate the features or other terms of interest once when performing multiple policy queries 610.

In certain embodiments, the policy queries 610 may only be processed when the query processing 612 module is first initialized. In certain embodiments the policy queries 610 may be reprocessed periodically by the query processing 612 module during event collection if they have been added to or otherwise changed. In certain embodiments, such reprocessing may be performed by periodically polling for configuration changes and reinitialize the query processing 612 module as needed. Certain embodiments of the invention reflect an appreciation that such reinitializing of the query processing 612 module facilitates the reduction of a policy query 610, which involves executing preliminary query steps against reference data. In certain embodiments, the reference data may be stored in a repository of persistent scoring data 668.

As an example, a policy query 610 may be for events associated with employees whose salary is greater than some amount. In this example, the first step is to identify who those employees may be, and once they are identified, include them into the query when it is “reduced.” It will be appreciated that failure to take this step may result in missing an employee got recently received a raise, and as a result, belongs in the group of identified employees. It will likewise be appreciated, that inclusion in the group of identified employees would typically not occur until the query processing 612 module was reinitialized. In certain embodiments, the query processing 612 module may be implemented to periodically recompile and re-reduce certain policy queries 610. In these embodiments, the method by which the decision is made to periodically recompile and re-reduce policy queries 610 is a matter of design choice.

In certain embodiments, the apply labels 614 module may be implemented to classify events by labeling them with associated classification labels. In certain embodiments, the labels applied by the apply labels 614 module may include associated metadata tags. In these embodiments, the method by which the apply labels 614 module selects a classification or metadata tag label, and the associated nomenclature thereof, is a matter of design choice.

As an example, an event may include a user downloading a file from a particular server address. In this example, the event may be classified as a “file download” with corresponding metadata of “server address.” Accordingly, the apply labels 614 module may apply both a “file download” classification label and a “server address” metadata tag label to the event. As another example, an event may include an employee using a badge to enter a secured facility after normal work hours. In this example, the event may be classified as “facility access,” with corresponding metadata of “secure” and “after hours.” Accordingly, the apply labels 614 module may apply a “facility access” classification label as well as “secure” and “after hours” metadata tag labels to the event.

In certain embodiments, the labels applied by the apply labels 614 module may be user-generated, user-edited, or a combination thereof. In various embodiments, certain labels applied by the apply labels 614 module may be applied automatically, corresponding to certain sets of conditions. In certain embodiments, the labels applied by the apply labels 614 module may be automatically or manually removed from certain interrelated events, based on inspection. In certain embodiments, the labels applied by the apply labels 614 module to one event may automatically or manually be added to another event. In certain embodiments, such addition of labels may be based upon a policy query 610 to provide bulk labeling of certain interrelated events that may share common features or other characteristics. In various embodiments, such addition of labels may be implemented to flag certain interrelated events as part of a review workflow.

In certain embodiments, labeled events generated by the apply labels 614 module may be processed by the feature extraction 616 module to generate configured features 620. In certain embodiments, the apply labels 614 and feature extraction 616 module may be implemented in combination to perform feature generation 618 operations. As used herein, a feature, as it relates to an event, broadly refers to a property, characteristic or attribute of a particular event. As an example, features associated with a corpus of thousands of text-oriented messages (e.g., SMS, email, social network messages, etc.) may be generated by removing low-value words (i.e., stopwords), using certain size blocks of words (i.e., n-grams), or applying various text processing rules. Examples of features associated with an event may include the number of bytes uploaded, the time of day, the presence of certain terms in unstructured content, the respective domains associated with senders and recipients of information, and the Uniform Resource Locator (URL) classification of certain web page visits.

As likewise used herein, feature extraction broadly refers to the selection of a subset of features associated with an event. In various embodiments, the feature extraction 616 module may be implemented to perform transformation operations on a group of features associated with an event to generate a smaller set of derived features. In certain embodiments, the feature extraction 616 module may be implemented to construct derived probabilistic models based upon a particular group of features. In certain embodiments, certain features may be aggregated, from which the derived probabilistic models may be constructed. In certain embodiments, the resulting derived probabilistic models may be aggregated into a scenario. As used herein, a scenario is broadly defined as a group of derived probabilistic models associated with a corresponding group of interrelated events.

Certain embodiments of the invention reflect an appreciation that the generation of derived features may be advantageous as various features associated with a particular event may represent a non-linear pattern or relationship corresponding to anomalous, abnormal, unexpected or malicious user behavior. Likewise, having too many features that may share similar attributes may result in multi-collinearity or otherwise confound certain statistical models. Accordingly, the performance of certain feature extraction operations to extract a minimal number of derived features may result in more accurately detecting anomalous, abnormal, unexpected or malicious user behavior. In certain embodiments, the feature extraction 616 module may be implemented to use certain scoring data stored in a repository of persistent scoring data 668, or event data stored in a repository of persistent event data 670, or a combination thereof, to generate the configured features 620.

FIG. 7 is a generalized process flow diagram of the performance of risk scoring operations implemented in accordance with an embodiment of the invention. In certain embodiments, risk scoring operations 420, described in greater detail herein, are initiated by the receipt of configured features 620 by a container initialization 702 module. In certain embodiments, the scoring container initialization 702 module may be implemented to determine whether feature matching operations, likewise described in greater detail herein, should be performed on a particular configured feature 620.

In certain embodiments, the determination of whether or not feature matching operations are performed may be dependent upon on the type of the feature. In certain embodiments, the type of the feature may be determined by an associated feature definition. In these embodiments, the method by which a feature definition is defined, determined, or associated with a corresponding feature is a matter of design choice.

In certain embodiments, events are not inspected prior to initializing scoring containers. In certain embodiments, a repository of persistent event data 670 may be queried for a random sampling of events containing the configured features 620. In certain embodiments, the resulting random sampling of events may be used during various scoring container initialization 702 operations to generate an initial probability distribution of their associated features. In certain embodiments, the initial probability distribution of associated features may likewise be stored in the repository of persistent event data 670 for re-use.

If so, then feature matching operations, described in greater detail herein, are performed on the extracted feature by a feature matching 704 module. If not, or once the feature matching operations are performed by the feature matching 704 module, feature scoring operations are performed on the configured feature 620 by a feature scoring 706 module. In certain embodiments, a pipeline 708 may be implemented to provide the configured feature 620 to the feature scoring 706 module once associated feature matching operations have been performed by the feature matching 704 module.

In certain embodiments, the results of the feature scoring operations performed by the feature scoring 706 module may be stored in the repository of persistent event data 670. In certain embodiments, the resulting scored features may then be to generate associated risk scores. In certain embodiments, the resulting risk scores may be provided as a risk service 424. In certain embodiments, the risk scores may be used by a security analytics system in the performance of operations associated with detecting anomalous, abnormal, unexpected or malicious user behavior.

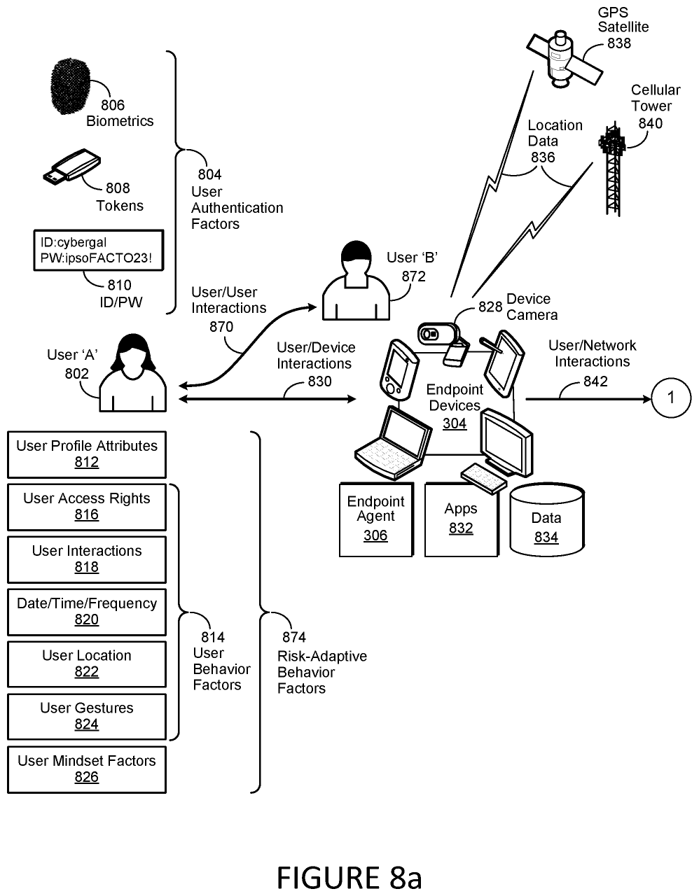

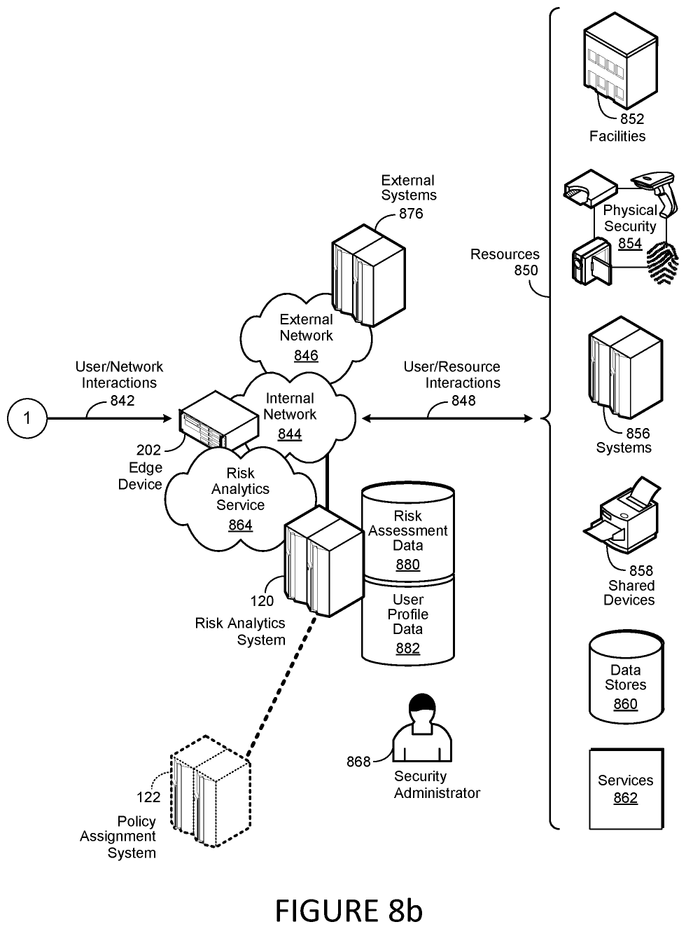

FIGS. 8a and 8b show a block diagram of a security analytics environment in which certain embodiments of the risk analytics system 120 may operate. In certain embodiments, analyses performed by the risk analytics system 120 may be used to identify anomalous, abnormal, unexpected or malicious behavior associated with an entity. In certain embodiments, the anomalous, abnormal, unexpected or malicious behavior may be identified at a particular point in time, during the occurrence of an event, the enactment of a user behavior, or a combination thereof. In certain embodiments, the risk analytics system 120 may be used to generate user risk assessments for use by the policy assignment system 122, as described in further detail herein.

In certain embodiments, information associated with a particular user behavior may be stored in a user profile. As used herein, a user profile broadly refers to a collection of information that uniquely describes a user's identity and their associated behavior, whether the behavior occurs within a physical realm or cyberspace. In certain embodiments, the user profile may be stored in a repository of user profile data 882. In certain embodiments, as described in greater detail herein, the user profile may include user profile attributes 812, user behavior factors 814, user mindset factors 826, or a combination thereof.

As used herein, a user profile attribute 812 broadly refers to data or metadata that can be used, individually or in combination with other user profile attributes 812, to uniquely ascertain the identity of an entity. In certain embodiments, the user profile attributes 812 may include certain personal information. In certain embodiments, the personal information may include non-sensitive personal information associated with a user, such as their name, title, position, role, and responsibilities. In certain embodiments, the personal information may likewise include technical skill level information, peer information, expense account information, paid time off (PTO) information, data analysis information, insider information, misconfiguration information, third party information, or a combination thereof.

In certain embodiments, the personal information may contain sensitive personal information associated with a user. As used herein, sensitive personal information (SPI), also commonly referred to as personally identifiable information (PII), broadly refers to any information usable to ascertain the identity of a user, either by itself, or in combination with other information, such as contextual information described in greater detail herein. Examples of SPI may include the full or legal name of a user, initials or nicknames, place and date of birth, home and business addresses, personal and business telephone numbers, their gender, and other genetic information.

Additional examples of SPI may include government-issued identifiers, such as a Social Security Number (SSN) or a passport number, vehicle registration plate and serial numbers, and driver's license numbers. Other examples of SPI may include certain email addresses and social media identifiers, financial account information, such as credit and debit card numbers, and other digital identity information. Yet other examples of SPI may include employer-issued identifiers, financial transaction information, credit scores, electronic medical records (EMRs), insurance claim information, personal correspondence, and so forth. Further examples of SPI may include user authentication factors 804.

In certain embodiments, the user authentication factors 804 may be used to authenticate the identity of a user, such as user ‘A’ 802 or ‘B’ 872. In certain embodiments, the user authentication factors 604 may be used to ensure that a particular user, such as user ‘A’ 802 or ‘B’ 872, is associated with their corresponding user profile, rather than a user profile associated with another user. In certain embodiments, the user authentication factors 604 may include a user's biometrics 806 (e.g., a fingerprint or retinal scan), tokens 808 (e.g., a dongle containing cryptographic keys), user identifiers and passwords (ID/PW) 810, and personal identification numbers (PINs).

As used herein, a user behavior factor 814 broadly refers to information associated with a user's behavior, whether the behavior occurs within a physical realm or cyberspace. In certain embodiments, the user behavior factors 814 may include the user's access rights 816, the user's interactions 818, and the date/time/frequency 820 of those interactions 818. In certain embodiments, the user behavior factors 814 may likewise include the user's location 822 when the interactions 818 are enacted, and the user gestures 824 used to enact the interactions 818.

In certain embodiments, the user gestures 824 may include key strokes on a keypad, a cursor movement, a mouse movement or click, a finger swipe, tap, or other hand gesture, an eye movement, or some combination thereof. In certain embodiments, the user gestures 824 may likewise include the cadence of the user's keystrokes, the motion, force and duration of a hand or finger gesture, the rapidity and direction of various eye movements, or some combination thereof. In certain embodiments, the user gestures 824 may include various audio or verbal commands performed by the user.

In various embodiments, certain date/time/frequency 820 user behavior factors 814 may be implemented as ontological or societal time, or a combination thereof. As used herein, ontological time broadly refers to how one instant in time relates to another in a chronological sense. As an example, a first user behavior enacted at 12:00 noon on May 17, 2017 may occur prior to a second user behavior enacted at 6:39 PM on May 18, 2018. Skilled practitioners of the art will recognize one value of ontological time is to determine the order in which various user behaviors have been enacted.

As likewise used herein, societal time broadly refers to the correlation of certain user profile attributes 812, user behavior factors 814, user mindset factors 826, or a combination thereof, to one or more instants in time. As an example, user ‘A’ 802 may access a particular system 856 to download a customer list at 3:47 PM on Nov. 3, 2017. Analysis of their user behavior profile indicates that it is not unusual for user ‘A’ 802 to download the customer list on a weekly basis. However, examination of their user behavior profile also indicates that user ‘A’ 802 forwarded the downloaded customer list in an email message to user ‘B’ 872 at 3:49 PM that same day. Furthermore, there is no record in their user behavior profile that user ‘A’ 802 has ever communicated with user ‘B’ 872 in the past. Moreover, it may be determined that user ‘B’ 872 is employed by a competitor. Accordingly, the correlation of user ‘A’ 802 downloading the customer list at one point in time, and then forwarding the customer list to user ‘B’ 872 at a second point in time shortly thereafter, is an example of societal time.

In a variation of the prior example, user ‘A’ 802 may download the customer list at 3:47 PM on Nov. 3, 2017. However, instead of immediately forwarding the customer list to user ‘B’ 872, user ‘A’ 802 leaves for a two week vacation. Upon their return, they forward the previously-downloaded customer list to user ‘B’ 872 at 9:14 AM on Nov. 20, 2017. From an ontological time perspective, it has been two weeks since user ‘A’ 802 accessed the system 856 to download the customer list. However, from a societal time perspective, they have still forwarded the customer list to user ‘B’ 872, despite two weeks having elapsed since the customer list was originally downloaded.

Accordingly, the correlation of user ‘A’ 802 downloading the customer list at one point in time, and then forwarding the customer list to user ‘B’ 872 at a much later point in time, is another example of societal time. More particularly, it may be inferred that the intent of user ‘A’ 802 did not change during the two weeks they were on vacation. Furthermore, user ‘A’ 802 may have attempted to mask an intended malicious act by letting some period of time elapse between the time they originally downloaded the customer list and when they eventually forwarded it to user ‘B’ 872. From the foregoing, those of skill in the art will recognize that the use of societal time may be advantageous in determining whether a particular user behavior is acceptable, anomalous, abnormal, unexpected or malicious.

As used herein, mindset factors 826 broadly refer to information used to determine the mental state of a user at a particular point in time, during the occurrence of an event, an enactment of a user behavior, or combination thereof. As used herein, mental state broadly refers to a hypothetical state corresponding to the way a user may be thinking or feeling. In certain embodiments, the user mindset factors 826 may include a personality type. Examples of known approaches for determining a personality type include Jungian types, Myers-Briggs type indicators, Keirsy Temperament Sorter, Socionics, Enneagram of Personality, and Eyseneck's three-factor model.

In certain embodiments, the mindset factors 826 may include various behavioral biometrics. As likewise used herein, a behavioral biometric broadly refers to a physiological indication of a user's mental state. Examples of behavioral biometrics may include a user's blood pressure, heart rate, respiratory rate, eye movements and iris dilation, facial expressions, body language, tone and pitch of voice, speech patterns, and so forth.

In certain embodiments, the risk analytics system 120 may be implemented to process certain entity information associated with providing resolution of the identity of an entity at a particular point in time. In certain embodiments, the risk analytics system 120 may be implemented to use information associated with certain user behavior elements to resolve the identity of an entity at a particular point in time. A user behavior element, as used herein, broadly refers to a discrete element of a user's behavior during the performance of a particular operation in a physical realm, cyberspace, or a combination thereof. In certain embodiments, such user behavior elements may be associated with a user/device 830, a user/network 842, a user/resource 848, a user/user 860 interaction, or a combination thereof.

As an example, user ‘A’ 802 may use an endpoint device 304 to browse a particular web page on a news site on the Internet. In this example, the individual actions performed by user ‘A’ 802 to access the web page are user behavior elements that constitute a user behavior. As another example, user ‘A’ 802 may use an endpoint device 304 to download a data file from a particular system 856. In this example, the individual actions performed by user ‘A’ 802 to download the data file, including the use of one or more user authentication factors 804 for user authentication, are user behavior elements that constitute a user behavior. In certain embodiments, the user/device 830 interactions may include an interaction between a user, such as user ‘A’ 802 or ‘B’ 872, and an endpoint device 304.

In certain embodiments, the user/device 830 interaction may include interaction with an endpoint device 304 that is not connected to a network at the time the interaction occurs. As an example, user ‘A’ 802 or ‘B’ 872 may interact with an endpoint device 304 that is offline, using applications 832, accessing data 834, or a combination thereof, it may contain. Those user/device 830 interactions, or their result, may be stored on the endpoint device 304 and then be accessed or retrieved at a later time once the endpoint device 304 is connected to the internal network 844 or external network 846. In certain embodiments, an endpoint agent 306 may be implemented to store the user/device 830 interactions when the user device 304 is offline.

In certain embodiments, an endpoint device 304 may be implemented with a device camera 828. In certain embodiments, the device camera 628 may be integrated into the endpoint device. In certain embodiments, the device camera 828 may be implemented as a separate device configured to interoperate with the endpoint device 304. As an example, a webcam familiar to those of skill in the art may be implemented receive and communicate various image and audio signals to an endpoint device 304 via a Universal Serial Bus (USB) interface.

In certain embodiments, the device camera 828 may be implemented to capture provide user/device 830 interaction information to an endpoint agent 306. In various embodiments, the device camera 828 may be implemented to provide surveillance information related to certain user/device 830 or user/user 870 interactions. In certain embodiments, the surveillance information may be used by the risk analytics system 120 to detect anomalous, abnormal, unexpected or malicious behavior associated with an entity, such as user ‘A’ 802 or user ‘B’ 872. In certain embodiments, the entity may or may not be aware that the camera is providing such surveillance information.

In certain embodiments, the endpoint device 304 may be used to communicate data through the use of an internal network 844, an external network 846, or a combination thereof. In certain embodiments, the internal network 844 and the external network 846 may include a public network, such as the Internet, a physical private network, a virtual private network (VPN), or any combination thereof. In certain embodiments, the internal network 844 and external network 846 may likewise include a wireless network, including a personal area network (PAN), based on technologies such as Bluetooth. In various embodiments, the wireless network may include a wireless local area network (WLAN), based on variations of the IEEE 802.11 specification, commonly referred to as WiFi. In certain embodiments, the wireless network may include a wireless wide area network (WWAN) based on an industry standard including various 3G, 4G and 5G technologies.

In certain embodiments, the user/user 870 interactions may include interactions between two or more users, such as user ‘A’ 802 and ‘B’ 862. In certain embodiments, the user/user interactions 870 may be physical, such as a face-to-face meeting, via a user/device 830 interaction, a user/network 842 interaction, a user/resource 848 interaction, or some combination thereof. In certain embodiments, the user/user 870 interaction may include a face-to-face verbal exchange. In certain embodiments, the user/user 870 interaction may include a written exchange, such as text written on a sheet of paper. In certain embodiments, the user/user 870 interaction may include a face-to-face exchange of gestures, such as a sign language exchange.

In certain embodiments, temporal event information associated with various user/device 830, user/network 842, user/resource 848, or user/user 870 interactions may be collected and used to provide real-time resolution of the identity of an entity at a particular point in time. Those of skill in the art will recognize that many such examples of user/device 830, user/network 842, user/resource 848, and user/user 870 interactions are possible. Accordingly, the foregoing is not intended to limit the spirit, scope or intent of the invention.

In various embodiments, the risk analytics system 120 may be implemented to process certain contextual information in the performance of certain security analytic operations. As used herein, contextual information broadly refers to any information, directly or indirectly, individually or in combination, related to a particular user behavior. In certain embodiments, user behavior may include a user's physical behavior, cyber behavior, or a combination thereof. As likewise used herein, a user's physical behavior broadly refers to any user behavior occurring within a physical realm, such as speaking, gesturing, facial patterns or expressions, walking, and so forth. More particularly, such physical behavior may include any action enacted by a user that can be objectively observed, or indirectly inferred, within a physical realm. In certain embodiments, the objective observation, or indirect inference, of the physical behavior may be performed electronically.

As an example, a user may attempt to use an electronic access card to enter a secured building at a certain time. In this example, the use of the access card to enter the building is the action and the reading of the access card makes the user's physical behavior electronically-observable. As another example, a first user may physically transfer a document to a second user, which is captured by a video surveillance system. In this example, the physical transferal of the document from the first user to the second user is the action. Likewise, the video record of the transferal makes the first and second user's physical behavior electronically-observable. As used herein, electronically-observable user behavior broadly refers to any behavior exhibited or enacted by a user that can be observed through the use of an electronic device (e.g., an electronic sensor), a computing device or system (e.g., an endpoint 304 or edge 202 device, a physical security device 854, a system 856, a shared device 858, etc.), computer instructions (e.g., a software application), or a combination thereof.

Cyber behavior, as used herein, broadly refers to any behavior occurring in cyberspace, whether enacted by an individual user, a group of users, or a system acting at the behest of an individual user, a group of users, or an entity. More particularly, cyber behavior may include physical, social, or mental actions that can be objectively observed, or indirectly inferred, within cyberspace. As an example, a user may use an endpoint device 304 to access and browse a particular website on the Internet. In this example, the individual actions performed by the user to access and browse the website constitute a cyber behavior. As another example, a user may use an endpoint device 304 to download a data file from a particular system 856 at a particular point in time. In this example, the individual actions performed by the user to download the data file, and associated temporal information, such as a time-stamp associated with the download, constitute a cyber behavior. In these examples, the actions are enacted within cyberspace, in combination with associated temporal information, which makes them electronically-observable.

In certain embodiments, the contextual information may include location data 836. In certain embodiments, the endpoint device 304 may be configured to receive such location data 836, which is used as a data source for determining the user's location 822. In certain embodiments, the location data 836 may include Global Positioning System (GPS) data provided by a GPS satellite 838. In certain embodiments, the location data 836 may include location data 836 provided by a wireless network, such as from a cellular network tower 840. In certain embodiments (not shown), the location data 636 may include various Internet Protocol (IP) or other network address information assigned to the endpoint 304 or edge 202 device. In certain embodiments (also not shown), the location data 836 may include recognizable structures or physical addresses within a digital image or video recording.

In certain embodiments, the endpoint devices 304 may include an input device (not shown), such as a keypad, magnetic card reader, token interface, biometric sensor, and so forth. In certain embodiments, such endpoint devices 304 may be directly, or indirectly, connected to a particular facility 852, physical security device 854, system 856, or shared device 858. As an example, the endpoint device 304 may be directly connected to an ingress/egress system, such as an electronic lock on a door or an access gate of a parking garage. As another example, the endpoint device 304 may be indirectly connected to a physical security device 854 through a dedicated security network.

In certain embodiments, the risk analytics system 120 may cooperate with the policy assignment system 122 to perform various risk-adaptive protection operations. Risk-adaptive, as used herein, broadly refers to adaptively responding to a risk associated with an electronically-observable user behavior. In various embodiments, the security analytics system 120 may be implemented to perform certain risk assessments that are used by the policy assignment system 122 to execute risk-adaptive protection operations. In certain embodiments, the risk analytics system 120 monitors certain user behaviors, assess the corresponding risk they may represent, individually or in combination, and communicates with the policy assignment system 122 to dynamically assign a group security policy to a given user as the risk assessment for the user changes. In certain embodiments, such responses may be based upon contextual information associated with a given user behavior.

In certain embodiments, various risk-adaptive behavior factors 874 may be used to perform the dynamic risk assessment operations. In certain embodiments, the risk-adaptive behavior factors 874 may include user profile attributes 812, user behavior factors 814, user mindset factors 826, or a combination thereof. In these embodiments, the risk-adaptive behavior factors 874 used to perform the risk-adaptive protection operations is a matter of design choice.

In certain embodiments, the risk analytics system 120 may be implemented as a stand-alone system. In certain embodiments, the risk analytics system 120 may be implemented as a distributed system. In certain embodiment, the risk analytics system 120 may be implemented as a virtual system, such as an instantiation of one or more virtual machines (VMs). In certain embodiments, the risk analytics system 120 may be implemented as a security analytics service 864. In certain embodiments, the security analytics service 864 may be implemented in a cloud environment familiar to those of skill in the art. In various embodiments, the risk analytics 120 may use data stored in a repository of security analytics data 880 in the performance of certain security risk assessment operations. Those of skill in the art will recognize that many such embodiments are possible. Accordingly, the foregoing is not intended to limit the spirit, scope or intent of the invention.

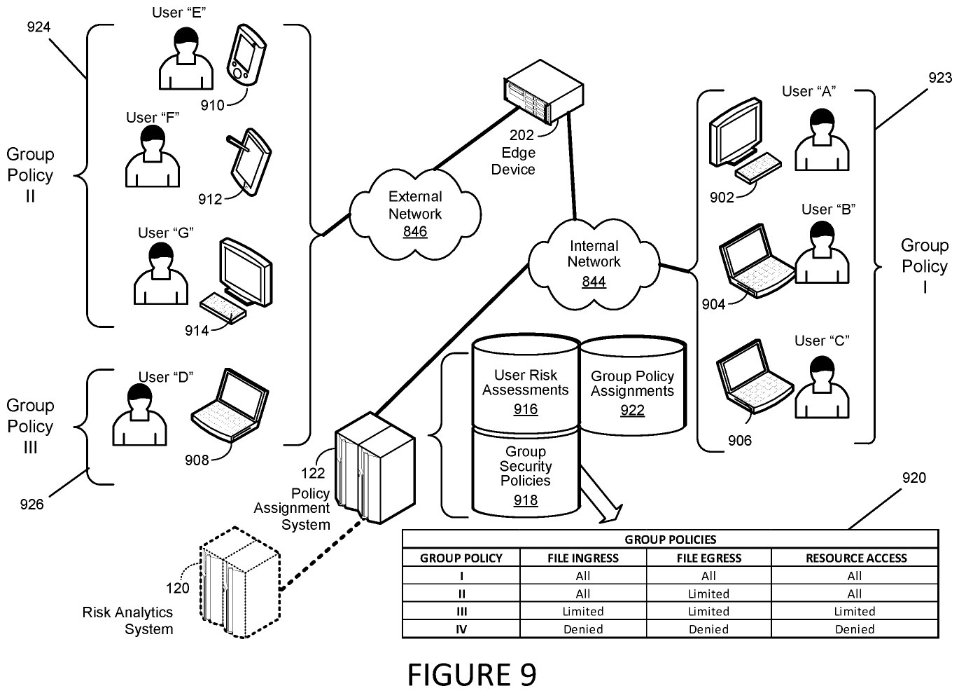

FIG. 9 is a functional block diagram showing an electronic environment in which certain embodiments of the policy assignment system 122 may operate in accordance with an embodiment of the invention. In certain embodiments, the policy assignment system 122 may be implemented to automatically assign group security policies to groups of users posing similar security risks. In various embodiments, certain electronically-observable information related to an organization and user behaviors are gathered and converted into electronic information related for use in providing a risk assessment for a user. As will be described herein, various factors may be used to assess the security risk for a given user.

For exemplary purposes, the electronic environment shown in FIG. 9 is described in the context of a network system with seven users—User “A”, User “B”, User “C”, User “D”, User “E”, User “F”, and User “G”. Each user interacts with the network using a respective endpoint device 902, 904, 906, 908, 910, 912, and 914. Users “A”, “B”, and “C” are in communication with the internal network 844, and are referenced herein as local users. Users “D”, “E”, “F”, and “G” are in communication with the edge device 202 over external network 846, and are referenced herein as remote users.

In certain embodiments, the policy assignment system 122 includes a user risk assessment datastore 916 and a group security policy datastore 918. In certain embodiments, the user risk assessment datastore 916 includes data used by the policy assignment system 122 to provide a risk assessment for each user “A” through “G”. In certain embodiments, a complete risk assessment for each user is determined by the risk analytics system 120. As an example, the risk analytics system 120 may provide the policy assignment system 122 with a risk score or risk level for each system user. In certain embodiments, the data analytics system 120 may provide the policy assignment system 122 with data relating to the status of a user. As an example, the data analytics system 120 may communicate a job function, employment status, local/remote status, or other user information that may be used by the policy assignment system 122 for risk assessment operations. Those skilled in the art will recognize, in view of the teachings of the present disclosure, that various combinations of such data may be used to assess the security risk posed by a user. In certain embodiments, the policy assignment system 122 combines users having similar risk assessments into common groups pursuant to assigning group security policies. Those skilled in the art will recognize, in view of the teachings of the present disclosure, that the specific manner and criterion used by the policy assignment system 122 to combine the users into common groups having similar risk assessments is a matter of design choice.

In certain embodiments, the policy assignment system 122 includes a group security policy datastore 918. In certain embodiments, the group security policy datastore 918 includes the parameters of group policies that are applied to user groups having similar risk assessments.

FIG. 9 includes a set of group security policies 920 that may be applied by the policy assignment system 122 to different user groups. In this example, the policy assignment system 122 includes four group policies I-IV having different security enforcement characteristics. In certain embodiments, the Group Policies I-V may provide different levels of security enforcement, where user groups having greater risk assessments are assigned a group policy having a greater level of security enforcement than group policies assigned to user groups having lower risk assessments.

In the example shown in FIG. 9, the group policies are illustrated with different characteristics for enforcement for file ingress, file egress, and resource access. In certain embodiments, Group Policy I allows ingress and egress of all files and access to all resources. In certain embodiments, the policy assignment system 122 may assign the substantially unlimited security characteristics provided by Group Policy I to a user group having low risk assessments. In certain embodiments, Group Policy II allows ingress of all files and access to all system resources. However, in the example of FIG. 9, Group Policy II limits egress of all files, specific files, or specific file types. In certain embodiments, the policy assignment system 122 may assign Group Policy II to a user group having mid-level risk assessments. In certain embodiments, Group Policy III limits ingress and egress of all files, specific files, or specific file types. In certain embodiments, the policy assignment system 122 may assign Group Policy III to a user group having high-level risk assessments. In certain embodiments, Group Policy IV denies ingress and egress of all files and, further, denies access to any system resources. In certain embodiments, the policy assignment system 122 may assign Group Policy IV to a user group having extremely high-level risk assessments.

It will be recognized by those skilled in the art, based on the teachings of the present disclosure, that other group policies having security characteristics other than those shown in the group security policies 920 may be employed. As an example, rather than limiting file ingress, file egress, and/or system resource access, group security policies may be developed that merely monitor one or more of such activities. As a further example, various group security policies may be developed that are directed to monitoring of specific user behaviors. These group security policy characteristics merely provide examples and are not intended to limit the scope of the present invention.

In certain embodiments, the policy assignment system 122 may include a datastore of group policy assignments 922. In certain embodiments, the group policy assignments 922 may include information relating to which group security policies have been assigned to different user groups. In certain embodiments, the group policy assignments 922 may include information as to which system users belong to common user group. In certain embodiments, the group policy assignments 922 may include information relating to criterion used to determine whether specific users are to be grouped with one another. In certain embodiments, the group policy assignments 922 may include information relating to reassignment of group security policies to one or more users based on changes to their user risk assessments. The foregoing information content of the group policy assignments 922 is merely exemplary and is not intended to limit the scope of the present disclosure.

In the example shown in FIG. 9, the policy assignment system 122 has identified three different user groups, where users in their respective user groups have common risk assessments. A determination as to which system users have common risk assessments may be based on various criterion. As an example, system users having risk scores and/or risk levels within a first set of predetermined limits may be assigned to a first user group, while system users having risk scores and/or risk levels within a second set of predetermined limits may be assigned to a second user group. In certain embodiments, a first group security policy may be assigned to users within the first user group, while a second group security policy may be assigned to users within the second user group. Additionally, or in the alternative, user status criterion such as job function, employment status, local/remote system use, etc., may be used to determine how system users are grouped with one another.

In the example of FIG. 9, the policy assignment system 122 as determined that User “A”, User “B”, and User “C” have similar risk assessments and placed them into user group 923. In this example, Group Policy I has been assigned to users within group 923. Further, in this example, the policy assignment system 122 has determined that User “E”, User “F”, and User “G” have similar risk assessments and placed them into the same group 924. Group Policy II has been assigned to users within group 924. Still further, the policy assignment system 122 has determined that User “D” has a risk assessment that meets a third set of one or more criterion and does not have a risk assessment similar to either group 923 or group 924. Accordingly, the policy assignment system 122 has placed the user within another user group 926, which has been assigned to operate in compliance with Group Policy III. In certain embodiments, risk assessments associated with each of the system users User “A” through User “G” may be updated dynamically allowing for dynamic reassignment of different group policies to different system users based on changes in the risk assessments for the system users. It will be recognized that such user groupings and policy assignments are merely exemplary and are not intended to limit the scope of the present disclosure.

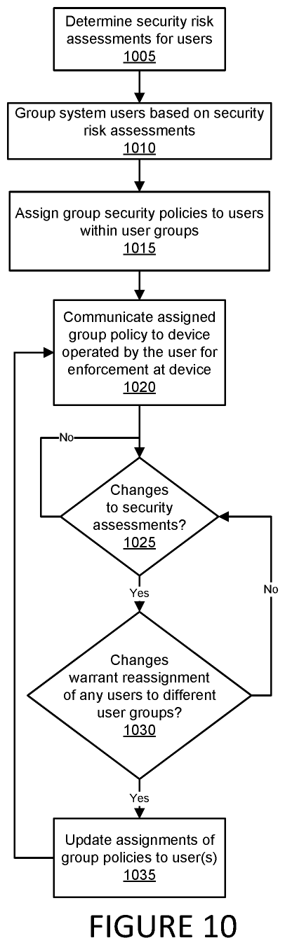

FIG. 10 is a flowchart depicting exemplary operations that may be executed by certain embodiments of the policy assignment system 122. In certain embodiments, a security risk assessment is determined for each of the system users at operation 1005. In certain embodiments, at operation 1010, the system users may be grouped into one or more common groups based on the security risk assessments. In certain embodiments, at operation 1015, a common group security policy is assigned to all users within a common user group. At operation 1020, certain embodiments communicate the assigned group policies to endpoint devices operated or otherwise associated with users within the common group. As an example of operation 1020, Group Policy I is communicated to endpoint devices 902, 904, and 906 respectively associated with User “A”, User “B”, and User “C” (FIG. 9). As such, Group Policy I is enforced at each endpoint device 902, 904, and 906. Also, as an example of operation of 1020, Group Policy II is communicated to endpoint devices 910, 912, and 914, respectively associated with User “E”, User “F”, and User “G”. As such, Group Policy II is enforced at endpoint devices 910, 912, and 914. Still further continuing with an example of operation 1020, Group Policy III is communicated to endpoint device 908 associated with User “D”. As such, Group Policy III is enforced at endpoint device 908.

In certain embodiments, the grouping at operation 1010 may be bypassed in favor of direct assignment (as opposed to a group assignment) of a group security policy to each user based on the security risk assessment associated with the user. In such instances, group security policies are applied to individual users as opposed to user groups.

In certain embodiments, a check is made at operation 1025 to determine whether any of the security risk assessments for the users have changed. In certain embodiments, if the security risk assessments have not changed, the policy assignment system may continue to check for security risk assessment changes at operation 1025 until a risk assessment change is detected. In certain embodiments, the check for security risk assessment changes may be executed on a periodic basis. In certain embodiments, the check for security risk assessment changes may be made in a per device basis. As one example, a check for a security risk assessment change for a given user may be executed when the user checks into the network system, as described in further detail below.

If changes to security assessments are detected at operation 1025, certain embodiments may determine whether the changes warrant reassignment of any users to a different user group at operation 1030. If no changes are warranted, the policy assignment system may return to monitoring for changes to security assessments at operation 1025. In certain embodiments, when reassignment of a user to another user group is warranted, certain embodiments update the group policy assigned to the reassigned user at operation 1035 and communicate the newly assigned group policy to the device operated by the reassigned user at operation 1020. It will be recognized that the operations shown in FIG. 10 are merely exemplary and are not intended to limit the scope of the present disclosure.

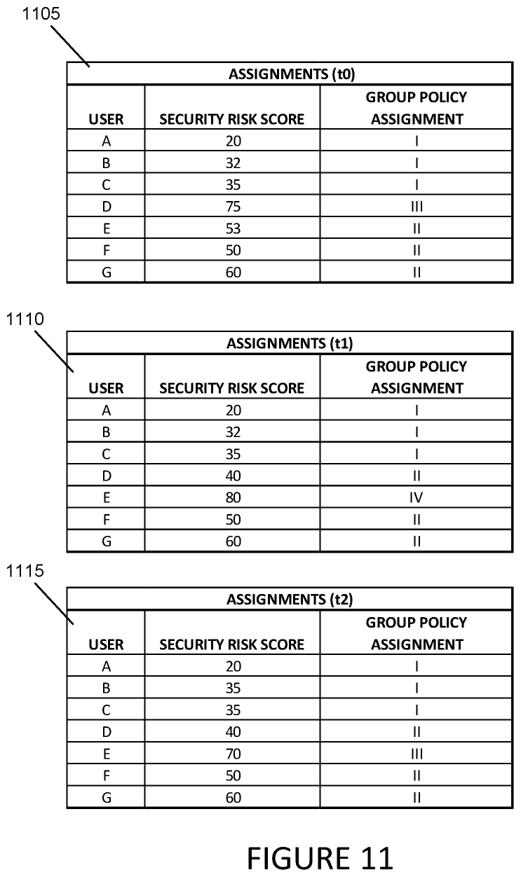

FIG. 11 includes charts 1105, 1110, and 1115 depicting group policy assignments to a plurality of users, User “A” through User “G”, at three different times t0, t1, and t2 in accordance with certain embodiments of the policy assignment system. In the example shown in FIG. 11, a security risk score for each user is employed to assign a particular group policy that is to be associated with the user. In this example, User “A” has a security risk score of 20, User “B” has a risk score of 32, and User “C” has a security risk score of 35 at time t0. The policy assignment system has determined that User “A”, User “B”, and User “C” have similar risk assessments since their respective security scores fall within a first predetermined range (e.g., 10-40). In certain examples, the policy assignment system may assign Group Policy I to users having risk scores falling within the first predetermined range. Accordingly, Group Policy I is communicated for enforcement at the devices associated with User “A”, User “B”, and User “C”.

To extend this example, User “E” has a security risk score of 53, User “F” has a risk score of 50, and User “G” has a security risk score of 60 at time t0. The policy assignment system has determined that User “E”, User “F”, and User “G” have similar risk assessments since their respective security scores fall within a second predetermined range (e.g., 41-60). In certain examples, the policy assignment system may assign Group Policy II to users having risk scores falling within the second predetermined range. Accordingly, Group Policy II is communicated for enforcement at the devices associated with User “E”, User “F”, and User “G”.

To further extend this example, User “D” has a security risk score of 75, at time t0. The policy assignment system has determined that User “D” has a security score falling within a third predetermined range (e.g., 61-79). In certain examples, the policy assignment system may assign Group Policy III to users having risk scores falling within the third predetermined range. Accordingly, Group Policy III is communicated for enforcement at the devices associated with User “D”.

Examples of security policy assignments at time t1 are depicted in chart 1110. In this example, the security risk score for User “D” has dropped from 75 to 40. Consequently, the security risk assessment for User “D” falls within the second predetermined range of 41-60. As such, Group Policy II is communicated for enforcement at the devices associated with User “D”. However, the security risk score for User “E” has increased to 80, falling within a fourth predetermined range (e.g. 80-100). For users having risk scores within the fourth predetermined range, the policy assignment system assigns Group Policy IV, which is communicated for enforcement at the devices associated with User “E”.

Examples of security policy assignments at time t2 are depicted in table 1115. In this example, the security risk score for User “B” has increased from 32 to 35. However, the security risk score of 35 remains in the first predetermined range. Consequently, devices associated with User “B” continue to execute Group Policy I. Likewise, User “D” has the same security risk score at time t2 as at the time t1. Accordingly, devices associated with User “D” continue to execute Group Policy II.

In the example depicted in table 1115, the risk score for User “E” has decreased from 80 at time t1 to 70 at time t2. Consequently, the security risk assessment for User “E” falls within the third predetermined range corresponding to application of Group Policy III. Accordingly, the policy assignment system assigns Group Policy III to User “E”, which is communicated for enforcement at the devices associated with User “E”.

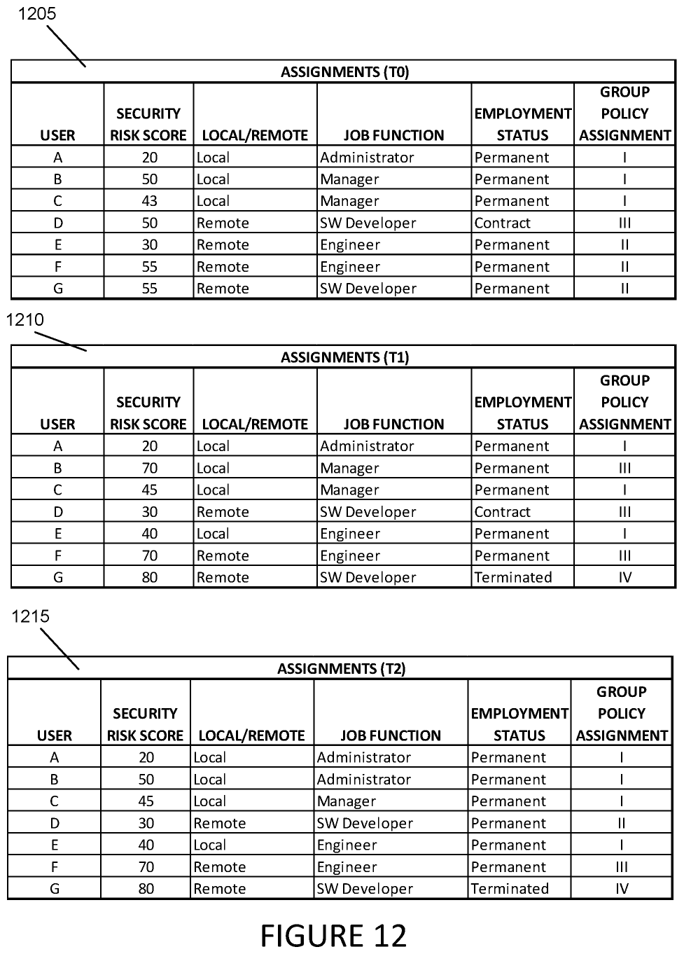

FIG. 12 includes charts 1205, 1210, and 1215 depicting exemplary assignment of group policies to a plurality of users, User “A” through User “G”, at three different times T0, T1, and T2. In this example, the security risk assessments may be based on one or more security factors, such as, a security risk score, a security risk level, whether the user operates locally or remotely, the job function of the user, and the employment status of the user. In arriving at a security risk assessment, the policy assignment system may assign a weight to each of the security factors so that security factors more likely to affect the security risk assessment have more influence in the security risk assessment than factors less likely to affect the security risk assessment. It will be recognized by those skilled in the art, based on the teachings of the present disclosure, that the weights given to the various security factors may be subjective and a matter of design choice.

Exemplary group security assignments for the system users, User “A” through User “G” at time T0 are depicted in chart 1205. In this example, Group Policy I is a group security policy limited to enforcing low-level security operations, and has been assigned to User “A”, User “B”, and User “C”. Group Policy II is a group security policy limited to enforcing mid-level security operations, and has been assigned to User “E”, User “F”, and User “G”. Group Policy III is a group security policy that enforces hi-level security operations, and has been assigned to User “D”.

Exemplary group security assignments for the system users, User “A” through User “G” at time T1 are depicted in chart 1210. In this example, the security risk score for User “B” has increased from 50 to 70. Since the increase in the security risk score may indicate risky behavior on the part of User “B”, the policy assignment system has reassigned Group Policy III to User “B”. Although the security risk score for User “C” has increased from 43 to 45 at time T1, the policy assignment system has determined that this increase, absent other changes, does not warrant a reassignment of a different group policy to User “C”. With reference to User “E”, the security risk score for User “E” has increased from 30 to 40, but User “E” is now working locally. In this example, the policy assignment system as determined that the fact that User “E” is now working locally (as opposed to remotely, where system breaches are more likely to occur) outweighs changes to the security risk score and assigns reduces the level of security imposed on User “E” from Group Policy III to Group Policy I. With reference to User “G”, the employment status for User “G” has changed from “Permanent” to “Terminated,” indicating that User “E” may not pose a significant risk. Consequently, the policy assignment system changes the policies executed by devices associated with User “E” from Group Policy II to Group Policy IV. It will be appreciated by those skilled in the art, in view of the present disclosure, that the changes in group security policy assignments made at time T1 are merely exemplary and are not intended to limit the scope of the present disclosure.

Exemplary group security assignments for the system users, User “A” through User “G” at time T2 are depicted in chart 1215. In this example, User “B” is now an “Administrator”. Since administrators are often trusted individuals and need access to substantially all of the files and resources of the system, the policy assignment system has changed the assigned policy for User “B” from Group Policy III to Group Policy I. Also in this example, the employment status for User “D” has changed from “Contract” to “Permanent” thereby indicating that User “D” may pose less of the security risk than an individual employed as a contractor. Accordingly, the policy assignment system has changed the security policy enforced at devices associated with User “D” from Group Policy III to Group Policy II. It will be appreciated by those skilled in the art, in view of the present disclosure, that the changes in group security policy assignments made at time T2 are merely exemplary and are not intended to limit the scope of the present disclosure.

In certain embodiments, others security risk factors may be used in determining the security risk assessment associated with a user. In certain embodiments, multiple security factors may be combined into a security risk score and used as a guideline for assigning the appropriate group security policy. In certain embodiments, the security risk assessment may include an analysis of a security risk sub-score which takes into account only certain security factors that would otherwise be taken into account in a composite risk score. In certain embodiments, the security risk assessment may include an analysis of a security risk level for the user. In certain embodiments, In certain embodiments, the security risk analysis may take into account a data exfiltration score for the user.

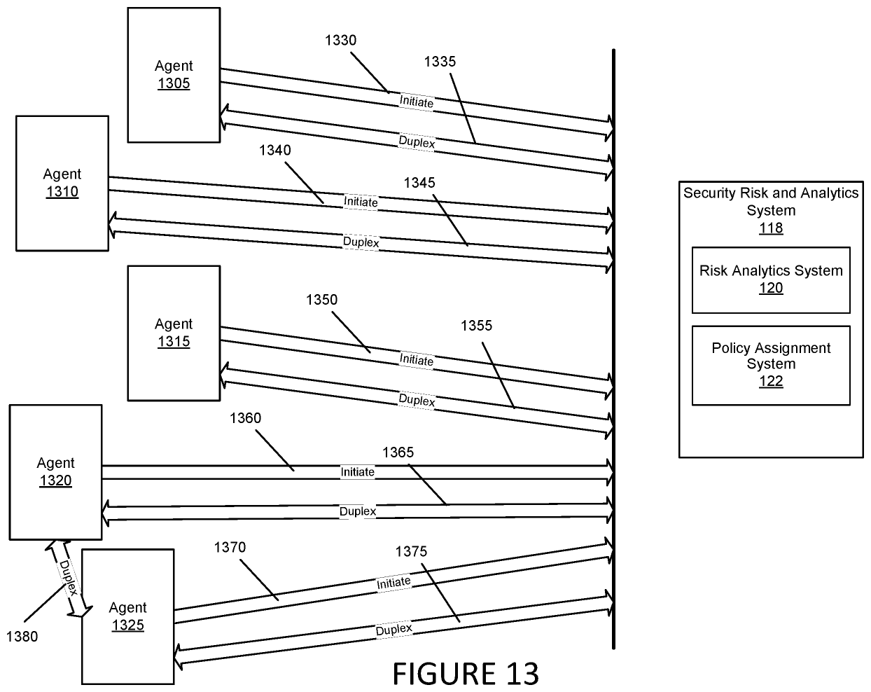

FIG. 13 is a block diagram illustrating one manner in which devices associated with system users may communicate with the security risk and analytics system 118 to, for example, transmit event information and receive group security policy assignments. In this example, a plurality of agents 1305, 1310, 1315, 1320, and 1325 reside on respective endpoint devices. In certain embodiments, the endpoint devices on which the agents reside are associated with different system users.

In certain embodiments, the security risk and analytics system 118 is not allowed to initiate communications with any of the agents. Accordingly, in certain embodiments, the agents initiate communication with the security risk and analytics system 118, after which duplex communication, including initial assignment and/or reassignment of group security policies, may occur. In the illustrated example, agent 1305 initiates communication with the security risk and analytics system 118 at operation 1330 followed by duplex communication at operation 1335. Agent 1310 initiates communication with the security risk and analytics system 118 at operation 1340 followed by duplex communication at operation 1345. Agent 1315 initiates communication with the security risk and analytics system 118 at operation 1350 followed by duplex communication at operation 1355. Agent 1320 initiates communication with the security risk and analytics system 118 at operation 1360 followed by duplex communication at operation 1365. Agent 1325 initiates communication with the security risk and analytics system 118 at operation 1370 followed by duplex communication at operation 1375. It will be recognized by those skilled in the art, in view of the present disclosure, that the illustrated communication operations are merely exemplary and not intended to limit the scope of the present disclosure.

In certain embodiments, communications may be initiated by one or more agents based on elapsed time since last communication, time of day, etc. In certain embodiments, the security risk and analytics system 118 may need to update the assignment of a group security policy for a given agent based on changes to the risk assessment for the user operating the device on which the agent resides. In certain instances, the security risk and analytics system 118 may determine that the group security policy update is important enough to dictate immediate communication of the group security policy to the given agent. In other instances, an agent may fail to initiate communication with the security risk and analytics system 118 and, as such, the group security policy is not updated within a desired timeframe.

In certain embodiments, the timing of the group policy update for a given agent may be addressed in several manners. As an example, assuming that agent 1320 has failed to check-in at its designated time or within a predetermined time frame, the security risk and analytics system 118 may identify an agent with which it is currently communicating, such as agent 1325. In certain embodiments, the security risk and analytics system 118 may direct agent 1325 to establish inter-agent communications with agent 1320, such as the duplex communication identified at operation 1380. In certain embodiments, agent 1325 may be used as a conduit to receive the updated group security on behalf of agent 1320 and policy transmit the security policy to the agents 1320. In certain embodiments, agent 1325 may be used to direct agent 1320 to check-in with the security risk and analytics system 118 to receive a group security policy update.

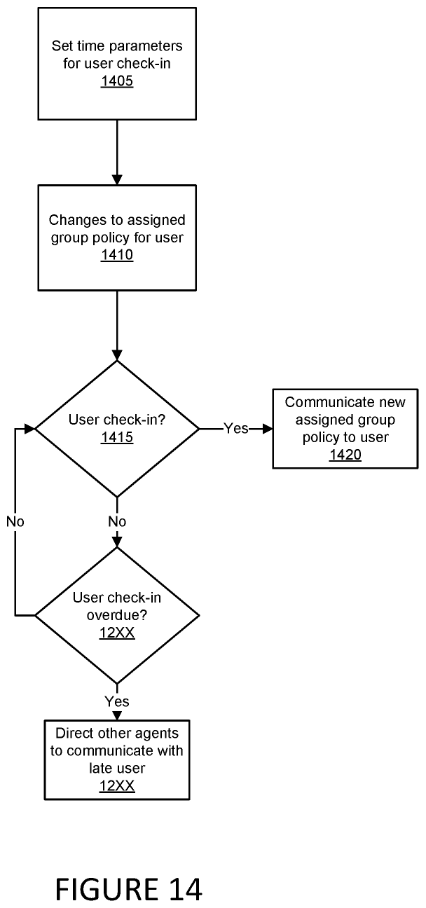

FIG. 14 is a flowchart depicting exemplary operations that may be executed to update a group security policy at an agent associated with a given user. In certain embodiments, the policy assignment system sets the time parameters for check-in of the given agent at operation 1405. In certain embodiments, it is determined at operation 1410 that changes to the assigned group policy are to be made for the given user. At operation 1415, a determination may be made as to whether the user has checked-in with the system 118. In certain embodiments, if the user (e.g., agent associated with the user) is currently checked-in, the newly assigned group security policy is communicated to devices associated with the user at operation 1420. If the user is not currently checked-in, a determination is made at operation 1425 as to whether a check-in for the user is overdue as per the time parameters set at operation 1405. If the check-in is not overdue, the system continues to monitor communications to detect check-in of the user at operation 1415 until such time as the user checks in or a check-in is overdue. If the check-in is overdue, the security analytics and policy assignment system 118 may direct other agents to communicate with the late user to convey the updated group security policy at operation 1430. Additionally, or in the alternative, the system 118 may direct other agents to order the late user to initiate communications with the system 118.

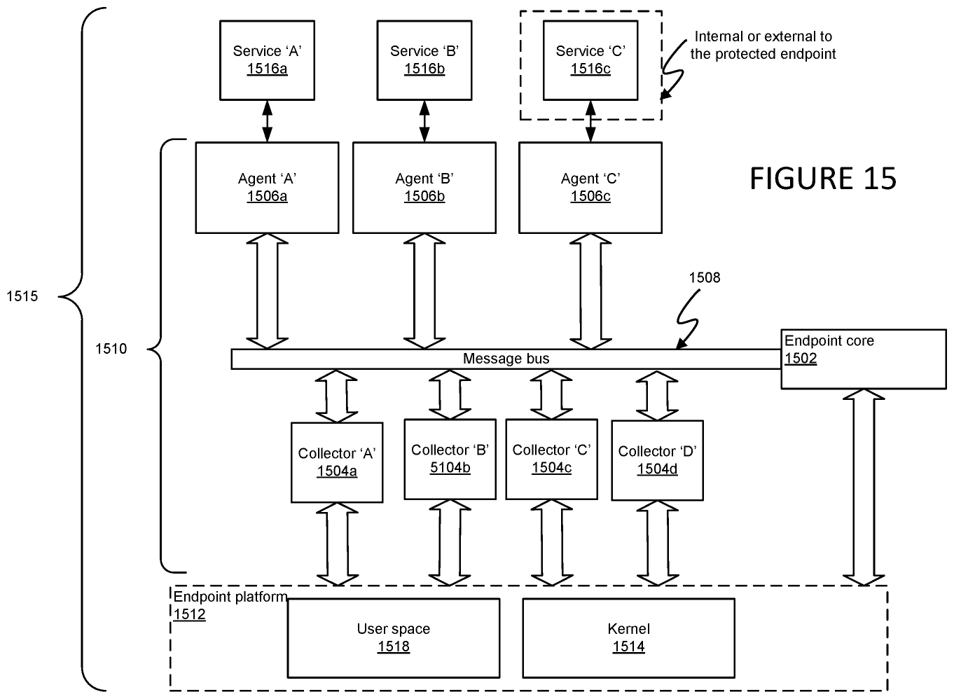

FIG. 15 is a block diagram showing one example of an implementation of a unified endpoint system 1510 that includes one or more agents that may be used at an endpoint device 1515. In certain embodiments, the unified endpoint system 1510 includes an endpoint core 1502 that is operable to configure one or more endpoint collectors 1504 and one or more endpoint agents 1506 over a common message bus 1508. In certain embodiments, such configuration operations may include initial loading of collectors 1504 and agents 1506 for use on the protected endpoint 1515. In certain embodiments, such configuration operations are static and only occur during initialization of the unified endpoint system 1510. In certain embodiments, the endpoint core 1502 may dynamically load, unload, and/or reconfigure the collectors 1504 and agents 1506 during operation of the protected endpoint 1515. In certain embodiments, the endpoint core 1502 operates as a conduit for communications between the endpoint collectors 1504 and endpoint agents 1506. In certain embodiments, the endpoint collectors 1504 and endpoint agents 1506 communicate with the endpoint core 1502 through one or more Application Programming Interfaces (APIs) to facilitate communications between the endpoint collectors 1504 and endpoint agents 1506. In certain embodiments, a single collector API is used to facilitate communications between the endpoint collectors 1504 and the endpoint core 1502. In certain embodiments, a single agent API is used to facilitate communications between the endpoint agents 1506 and the endpoint core 1502.

In certain embodiments, the endpoint collectors 1504 are configured to detect activities occurring on an endpoint platform 1512. As used herein, an endpoint platform includes, without limitation, the kernel 1514 and/or user space 1518 operating at an endpoint device 1505. In certain embodiments, one or more of the endpoint collectors 1504 may be configured to detect activities occurring in the kernel 1514 of the endpoint platform 1512. In certain embodiments, activities occurring in the kernel 1514 may include filesystem activity, process activity, information relating to endpoint device performance metrics, etc. In certain embodiments, one or more of the endpoint collectors 1504 may be configured to detect activities occurring in the user space 1518 of the endpoint platform 1512. In certain embodiments, activities occurring in user space 1518 may include network activity, web browser activity, web browser extension activity, etc. In certain embodiments, all endpoint collectors 1504 of the unified endpoint system 1510 are configured to detect activities in the kernel 1514, while activities within user space 1518 are ignored. In certain embodiments, all endpoint collectors 1504 of the unified endpoint system 1510 are configured to detect activities in the user space 1518, while activities within kernel 1514 are ignored. In certain embodiments, one or more of the endpoint collectors 1504 are configured to detect activities in the kernel 1514, while other endpoint collectors 1504 are configured to detect activities in the user space 1518. In certain embodiments, a single collector 1504 may be configured to filter activities and/or of events occurring on the endpoint platform 1512 so that only certain activities and/or events at the input of the collector 1504 are used to generate the corresponding events which the collector 1504 places on the message bus 1508. It will be recognized, in view of the present disclosure, that various endpoint collector combinations and corresponding filter configurations may be employed to provide the desired event information on the message bus 1508.

In certain embodiments, the activities received by one or more of the endpoint collectors 1504 include raw activity information that the endpoint collector converts to events corresponding to the detected raw activities. In certain embodiments, raw activities may be provided from the kernel 1514. In certain embodiments, the activities received by one or more of the endpoint collectors 1504 are in the form of events corresponding to activities occurring on the endpoint platform 1512. In certain embodiments, such events may be provided from the user space 1518 and/or kernel 1514. In certain embodiments, events corresponding to the detected activities and/or events received by one or more of the endpoint collectors 1504 are placed on the common message bus 1508 by the endpoint collectors 1504.

The example shown in FIG. 15 also includes a plurality of endpoint agents 1506 configured to receive events from the endpoint collectors 1504 over the message bus 1508. In certain embodiments, each endpoint agent 1506 is configured to selectively process only those events on the message bus 1508 to which the endpoint agent 1506 has subscribed. As used herein, selective processing refers to actual processing of the received event data to provide information for further processing by a security service, and/or pass-through of one or more of the subscribed events to a security service. In certain embodiments, an endpoint agent 1506 may add any communication overhead to a pass-through event needed to transfer the events from the endpoint agent 1106 to a security service 1116.

In certain embodiments, a given endpoint agent 1506 may subscribe to events from multiple collectors 1504, a subset of events from multiple collectors 1504, or a subset of events from a single collector 1104. For example, Agent ‘A’ 1506a may subscribe to all events provided on the message bus 1508 from both Collector ‘A’ 1504a and Collector ‘B’ 1504b. In another example, Agent ‘A’ 1506a may subscribe to only a subset of events provided on the message bus 1508 from Collector ‘A’ 1504a and Collector ‘B’ 1504b. In another example, Agent ‘A’ 1506a may subscribe to only a subset of events provided on the message bus 1508 from Collector ‘B’ 1504b. These examples may be extended to subscriptions by each endpoint agent 1506 for events generated by each collector 1504 thereby illustrating the versatile manner in which selective processing of events by the endpoint agents 1506 may be implemented. Since only those events to which an endpoint agent 1506 has subscribed are selectively processed by the endpoint agent 1506, processing of events that are not relevant to the endpoint agent 1506 are avoided thereby reducing the amount of processing resources needed by an endpoint agent to execute the processes for which it is designed.

In the example shown in FIG. 15, each of the endpoint agents 1506 is configured with a service connection to provide information to one or more corresponding security services 1516. In certain embodiments, one or more of the security services 1515 may be configured to receive group security policies from the security analytics and policy assignment system 118. The information provided by an endpoint agent to a security service 1516 is based on events that are selectively processed by the endpoint agent 1506. As used herein, a security service generally refers to the utility of a functional module and is not limited to functions that run as services within the context of an operating system. In certain embodiments, each endpoint agent 1506 is associated with a respective security service 1516. In the illustrated example, Agent ‘A’ 1506a has a service connection with Service ‘A’ 1516a, Agent ‘B’ 1506b has a service connection with Service ‘B’ 1516b, and Agent ‘C’ 1506c is a service connection with Service ‘C’ 1516c.

In certain embodiments, some of the security services 1516 are implemented within the protected endpoint 1515. Such services are shown in FIG. 15 as Service ‘A’ 1516a and Service ‘B’ 1516b. In certain embodiments, one or more security services 1516 may be implemented on the protected endpoint or on a platform exterior to the protected endpoint 1515. One such service is shown in FIG. 15 as Service ‘C’ 1516c. In certain embodiments, primary security services required during operation of the protected endpoint 1515 may be implemented at the protected endpoint 1515, while secondary security services not required during operation of the protected endpoint 1515 may be offloaded to an exterior platform. In certain embodiments, some security services may be included as a set of standard security services that are consistently provided on a protected endpoint 1515, while optional security services may be provided as add-ons. The architecture and operation of the unified endpoint system 1510 provides the versatility and flexibility to provide such options.

In certain embodiments, the events to which an endpoint agent 1506 subscribes may be limited to those events that are needed by the endpoint agent 1506 to provide the information required by the connected security service 1516. In certain embodiments, the information provided from a given endpoint agent 1506 to a given security service 1516 is generated by directly executing processing operations on the subscribed event data itself. Additionally, or on the alternative, the endpoint agent 1506 may operate as a conduit for passing subscribed events to the connected security service 1516 without directly processing the actual data of the subscribed events. In certain embodiments, subscribed events that are passed directly through the endpoint agent 1506 to the corresponding security service 1516 may include additional communication overhead unrelated to direct processing of the data of the subscribed event.

Certain embodiments of the unified endpoint system 1510 provide a versatile and flexible platform for executing security services based on events occurring in different portions of the endpoint platform 1512. In certain embodiments, different endpoint agents 1506 may subscribe to one or more of the same events thereby allowing the same events to be viewed from different security perspectives by the endpoint agents 1506 and security services 1516. In certain embodiments, the configuration of the unified endpoint system 1510 may be programmed remotely through the endpoint core 1502 to implement various combinations and configurations for the endpoint collectors 1504 and endpoint agents 1506.

In certain embodiments, the activities and/or events collected by a collectors 1504 may be dynamically controlled based on the efficiency of the collector's processing operations. For example, an endpoint collector may be dynamically configured to only process a reduced subset of the total activities/events that it is designed to collect. In certain embodiments, an endpoint collector may be dynamically configured to reduce the frequency with which it collects one or more activities/events. In certain embodiments, the unified endpoint system 1510 may operate to implement multiple dynamic configurations depending on the degree of processing efficiency of the endpoint collector.

In certain embodiments, the events to which an endpoint agent 1506 may be dynamically controlled based on the efficiency of the endpoint agent's and/or security service's processing operations. For example, an endpoint agent may be dynamically configured to reduce the number and/or type of events to which it subscribes, where the endpoint agent subscribes to a higher number and/or more complex set of events during optimal efficiency, and subscribes to a reduced subset of event types and/or number of events when efficiency is less than optimal. In certain embodiments, an endpoint agent may be dynamically configured to reduce the frequency at which it processes one or more subscribed events. In certain embodiments, the unified endpoint system 1510 may operate to implement multiple dynamic configurations of an endpoint agent 1506 depending on the degree of processing efficiency of the endpoint agent.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention. Consequently, the invention is intended to be limited only by the spirit and scope of the appended claims, giving full cognizance to equivalents in all respects.

What is claimed is:

1. A computer-implemented method for assigning security policy to a user, comprising:
providing a plurality of group security policies, wherein one or more of the plurality of group security policies have different levels of security enforcement;
receiving a security risk assessment for the user;
assigning a group security policy from the plurality of group security policies to the user based on the security risk assessment for the user; and
communicating the assigned group security policy to a device operated by the user for enforcement of the group security policy at the device.

2. The computer-implemented method of claim 1, further comprising:
dynamically responding to changes in the security risk assessment for the user by changing the group security policy to which the user is assigned, wherein
a group security policy from the plurality of group security policies having a higher level of security enforcement is assigned to the user in response to changes in the security risk assessment indicating that the user poses an increased security risk; and
a group security policy from the plurality of group security policies having a lower level of security enforcement is assigned to the user in response to changes in the security risk assessment indicating that the user poses a lowered security risk.

3. The computer-implemented method of claim 1, wherein the security risk assessment includes one or more of:
a security risk level;
a composite security risk score;
a security risk sub-score; and
a data exfiltration score.

4. The computer-implemented method of claim 1, wherein
the security risk assessment for the user is received from a security analytics system, wherein the security analytics system dynamically updates the security risk assessment for the user based on one or more of:
user behavior at the device operated by the user;
user interactions with a system resource; and
user interactions with other user devices.

5. The computer-implemented method of claim 4, wherein
the security risk assessment for the user is received from the security analytics system at an API.

6. The computer-implemented method of claim 1, wherein
the assigned group security policy is communicated from a server to an agent of an endpoint device operated by the user for enforcement of the assigned group security policy at the endpoint device.

7. The computer-implemented method of claim 6, further comprising:
initiating communications by the agent at the endpoint device with the server in response to occurrence of one or more of
a scheduled communication time assigned to the endpoint device;
a communication timeout at the endpoint device; and
a violation of a security policy rule at the endpoint device.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing a plurality of group security policies, wherein one or more of the plurality of group security policies have different levels of security enforcement;
receiving a security risk assessment for a user;
assigning a group security policy from the plurality of group security policies to the user based on the security risk assessment for the user; and
communicating the assigned group security policy to a device operated by the user for enforcement of the group security policy at the device.

9. The system of claim 8, wherein the instructions are further configured for:
dynamically responding to changes in the security risk assessment for the user by changing the group security policy to which the user is assigned, wherein
a group security policy from the plurality of group security policies having a higher level of security enforcement is assigned to the user in response to changes in the security risk assessment indicating that the user poses an increased security risk; and
a group security policy from the plurality of group security policies having a lower level of security enforcement is assigned to the user in response to changes in the security risk assessment indicating that the user poses a lowered security risk.

10. The system of claim 8, wherein the security risk assessment includes one or more of:
a security risk level;
a composite security risk score;
a security risk sub-score; and
a data exfiltration score.

11. The system of claim 8, wherein
the security risk assessment for the user is received from a security analytics system, wherein the security analytics system dynamically updates the security risk assessment for the user based on one or more of:
user behavior at the device operated by the user;
user interactions with a system resource; and
user interactions with other user devices.

12. The system of claim 11, wherein
the security risk assessment for the user is received from the security analytics system at an API.

13. The system of claim 8, wherein
the assigned group security policy is communicated from a server to an agent of an endpoint device operated by the user for enforcement of the assigned group security policy at the endpoint device.

14. The system of claim 13, wherein the instructions are further configured for:
initiating communications by the agent at the endpoint device with the server in response to occurrence of one or more of
a scheduled communication time assigned to the endpoint device;
a communication timeout at the endpoint device; and
a violation of a security policy rule at the endpoint device.

15. A non-transitory, computer-readable storage medium embodying computer program code, the computer program code comprising computer executable instructions configured for:
providing a plurality of group security policies, wherein one or more of the plurality of group security policies have different levels of security enforcement;
receiving a security risk assessment for a user;
assigning a group security policy from the plurality of group security policies to the user based on the security risk assessment for the user; and
communicating the assigned group security policy to a device operated by the user for enforcement of the group security policy at the device.

16. The non-transitory, computer-readable storage medium of claim 15, wherein the instructions are further configured for:
dynamically responding to changes in the security risk assessment for the user by changing the group security policy to which the user is assigned, wherein
a group security policy from the plurality of group security policies having a higher level of security enforcement is assigned to the user in response to changes in the security risk assessment indicating that the user poses an increased security risk; and
a group security policy from the plurality of group security policies having a lower level of security enforcement is assigned to the user in response to changes in the security risk assessment indicating that the user poses a lowered security risk.

17. The non-transitory, computer-readable storage medium of claim 15, wherein the security risk assessment includes one or more of:
a security risk level;
a composite security risk score;
a security risk sub-score; and
a data exfiltration score.

18. The non-transitory, computer-readable storage medium of claim 15, wherein
the security risk assessment for the user is received from a security analytics system, wherein the security analytics system dynamically updates the security risk assessment for the user based on one or more of:
user behavior at the device operated by the user;
user interactions with a system resource; and
user interactions with other user devices.

19. The non-transitory, computer-readable storage medium of claim 18, wherein
the security risk assessment for the user is received from the security analytics system at an API.

20. The non-transitory, computer-readable storage medium of claim 15, wherein
the assigned group security policy is communicated from a server to an agent of an endpoint device operated by the user for enforcement of the assigned group security policy at the endpoint device.
